(19) United States
(12) Patent Application Publication
(10) Pub. No.: US 2026/0222047 A1
(43) Pub. Date: Jul. 30, 2026

(54) RELAY DEVICE, COMMUNICATION DEVICE, AND COMMUNICATION METHOD

(71) Applicant: Sony Group Corporation, Tokyo (JP)

(72) Inventors: Kazuyuki SHIMEZAWA, Kanagawa (JP); Ren SUGAI, Kanagawa (JP)

(73) Assignee: Sony Group Corporation, Tokyo (JP)

(21) Appl. No.: 19/144,965

(22) PCT Filed: Apr. 17, 2024
(86) PCT No.: PCT/JP2024/015205

§ 371 Date: Jul. 1, 2025

(30) Foreign Application Priority Data
Apr. 21, 2023 (JP) 2023-070399

(51) Int. Cl. H04B 7/06; H04W 72/25

(52) U.S. Cl. CPC H04B 7/06954; H04W 72/25

(57) ABSTRACT

A relay device can include a relay unit. The relay unit transmits a sidelink signal transmitted from a transmission device through a first link to a reception device through a second link according to control information. The control information is notified by at least one of a base station, the transmission device, the reception device, or a communication device.

### TECHNICAL FIELD

The present disclosure relates to a relay device, a communication device, and a communication method.

### BACKGROUND ART

In recent years, sidelink communication has attracted attention. For example, in recent years, device-to-device (D2D) communication for performing direct communication between terminal devices (user equipment (UE)) has attracted attention as a form of sidelink communication.

### CITATION LIST

### Non Patent Literature

NPL 1: “TS22.186, 3rd Generation Partnership Project; Technical Specification Group Services and System Aspects; Enhancement of 3GPP support for V2X scenarios; Stage 1 (Release 16)”, [online], [searched on Apr. 12, 2023], Internet<https://www.3gpp.org/ftp//Specs/archive/22_series/22.186/22186-g20.zip>

NPL 2: “TR 38.867, 3rd Generation Partnership Project; Technical Specification Group Radio Access network; Study on NR network-controlled repeaters; (Release 18)”, [online], [searched on Apr. 12, 2023], Internet<URL: https://www.3gpp.org/ftp/Specs/archive/38_series/38.867/38867-100.zip>

### SUMMARY OF INVENTION

### Technical Problem

A radio propagation environment of sidelink communication is the line-of-sight (LOS) or non-line-of-sight (NLOS) depending on the presence or absence of a structure between UEs that perform the sidelink communication. Also in the sidelink communication, a communication quality in the NLOS environment is lower than that in the LOS environment.

Therefore, the present disclosure provides a mechanism capable of suppressing deterioration of a communication quality in an NLOS environment in sidelink communication.

It should be noted that the above-mentioned problem or purpose is only one of a plurality of problems or purposes that can be solved or achieved by a plurality of embodiments disclosed in the present specification.

### Solution to Problem

A relay device of the present disclosure includes a relay unit. The relay unit transmits a sidelink signal transmitted from a transmission device through a first link to a reception device through a second link according to control information. The control information is notified by at least one of a base station, the transmission device, the reception device, or a communication device.

### BRIEF DESCRIPTION OF DRAWINGS

FIG. 1 a diagram illustrating an overview of sidelink communication.

FIG. 2 is a diagram illustrating an example of mapping of a sidelink physical channel to a physical resource (time-frequency resource).

FIG. 3 is a diagram for describing an example of SL sensing.

FIG. 4 is a diagram for describing another example of the SL sensing.

FIG. 5 is a diagram illustrating an example of an NCR.

FIG. 6 is a diagram illustrating an example of a configuration of a communication system according to an embodiment of the present disclosure.

FIG. 7 is a diagram illustrating an example of a configuration of a base station according to an embodiment of the present disclosure.

FIG. 8 is a diagram illustrating an example of a configuration of a terminal device according to an embodiment of the present disclosure.

FIG. 9 is a diagram illustrating an example of a configuration of a relay device according to an embodiment of the present disclosure.

FIG. 10 is a diagram for describing a first control method according to an embodiment of the present disclosure.

FIG. 11 is a sequence diagram illustrating an example of a flow of the first control method according to an embodiment of the present disclosure.

FIG. 12 is a diagram for describing a second control method according to an embodiment of the present disclosure.

FIG. 13 is a sequence diagram illustrating an example of a flow of the second control method according to an embodiment of the present disclosure.

FIG. 14 is a diagram for describing a third control method according to an embodiment of the present disclosure.

FIG. 15 is a sequence diagram illustrating an example of a flow of the third control method according to an embodiment of the present disclosure.

FIG. 16 is a diagram for describing a fourth control method according to an embodiment of the present disclosure.

FIG. 17 is a sequence diagram illustrating an example of a flow of the fourth control method according to an embodiment of the present disclosure.

FIG. 18 is a diagram illustrating a first example of mapping of a dedicated control channel according to an embodiment of the present disclosure.

FIG. 19 is a diagram illustrating a second example of the mapping of the dedicated control channel according to an embodiment of the present disclosure.

FIG. 20 is a diagram illustrating a first example of mapping of an existing control channel according to an embodiment of the present disclosure.

FIG. 21 is a diagram illustrating a second example of the mapping of the existing control channel according to an embodiment of the present disclosure.

FIG. 22 is a diagram illustrating a third example of the mapping of the existing control channel according to an embodiment of the present disclosure.

FIG. 23 is a sequence diagram illustrating an example of a flow of a first acquisition method for CSI in a case where an RIS according to an embodiment of the present disclosure is non-transparent.

FIG. 24 is a sequence diagram illustrating an example of a flow of a second acquisition method for the CSI in a case where the RIS according to an embodiment of the present disclosure is non-transparent.

FIG. 25 is a sequence diagram illustrating an example of a flow of a third acquisition method for the CSI in a case where the RIS according to an embodiment of the present disclosure is non-transparent.

FIG. 26 is a sequence diagram illustrating an example of a flow of a fourth acquisition method for the CSI in a case where the RIS according to an embodiment of the present disclosure is non-transparent.

FIG. 27 is a sequence diagram illustrating an example of a flow of a fifth acquisition method for the CSI in a case where the RIS according to an embodiment of the present disclosure is non-transparent.

FIG. 28 is a sequence diagram illustrating an example of a flow of a sixth acquisition method for the CSI in a case where the RIS according to an embodiment of the present disclosure is non-transparent.

FIG. 29 is a sequence diagram illustrating an example of a flow of a seventh acquisition method for the CSI in a case where the RIS according to an embodiment of the present disclosure is non-transparent.

FIG. 30 is a sequence diagram illustrating an example of a flow of an eighth acquisition method for the CSI in a case where the RIS according to an embodiment of the present disclosure is non-transparent.

FIG. 31 is a sequence diagram illustrating an example of a flow of an acquisition method for the CSI in a case where the RIS according to an embodiment of the present disclosure is transparent.

FIG. 32 is a sequence diagram illustrating an example of a flow of an RIS selection operation of selecting the RIS by a transmission device according to an embodiment of the present disclosure.

FIG. 33 is a sequence diagram illustrating an example of a flow of an RIS selection operation of selecting the RIS by a reception device according to an embodiment of the present disclosure.

FIG. 34 is a sequence diagram illustrating an example of a flow of an RIS selection operation of selecting the RIS by the base station according to an embodiment of the present disclosure.

### DESCRIPTION OF EMBODIMENTS

Hereinafter, embodiments of the present disclosure will be described in detail with reference to the appended drawings. Note that, in the present specification and the drawings, components having substantially the same functional configuration are denoted by the same reference signs, so that an overlapping description of these components is omitted.

In addition, in the present specification and drawings, similar components of embodiments may be distinguished by adding at least one of different alphabets or numerals after the same reference sign. However, in a case where it is not necessary to particularly distinguish each of similar components, only the same reference sign is assigned. For example, a plurality of components having substantially the same functional configuration are distinguished as necessary, such as a terminal device 40_1 and a terminal device 40_2. For example, in a case where it is not necessary to particularly distinguish the terminal device 40_1 and the terminal device 40_2, they are simply referred to as the terminal device 40.

Each of one or more embodiments (including examples, modified examples, and application examples) described below can be implemented independently. On the other hand, at least some of the plurality of embodiments described below may be implemented in combination with at least some of other embodiments as appropriate.

These plurality of embodiments may include novel characteristics different from each other. Therefore, these plurality of embodiments can contribute to achieve or solving different purposes or problems, and can exert different effects.

### 1. Introduction

### 1-1. Sidelink Communication

In the 3GPP (registered trademark), device-to-device (D2D) communication for performing direct communication between terminals (user equipment (UE)) is standardized as sidelink communication in 4G long term evolution (LTE) and 5G new radio (NR), respectively.

In the sidelink communication, vehicle-to-everything (V2X) communication is one of main use cases. The V2X communication is assumed to be vehicle-to-vehicle (V2V) communication, vehicle-to-infrastructure (V2I) communication, vehicle-to-pedestrian (V2P) communication, or vehicle-to-network (V2N) communication.

Particularly, in the sidelink communication in 5G NR, Platooning, Advanced Driving, Extended Sensors, and Remote Driving are assumed as advanced V2X communication. In the sidelink communication in 5G NR, standards are formulated in such a way as to implement high-speed and large-capacity communication and/or low-latency and high-reliability communication as compared with the sidelink communication in 4G LTE.

As a use case of the sidelink communication, extension and application to commercial use (commercial use case) used in houses, offices, and factories are expected in addition to the conventional V2X communication.

As one solution thereof, it has been proposed to use an unlicensed band (unlicensed spectrum or shared spectrum) in which a license is unnecessary for use of a predetermined frequency band, and it is expected to be standardized in NR Release-18.

### 1-1-1. Overview of Sidelink Communication

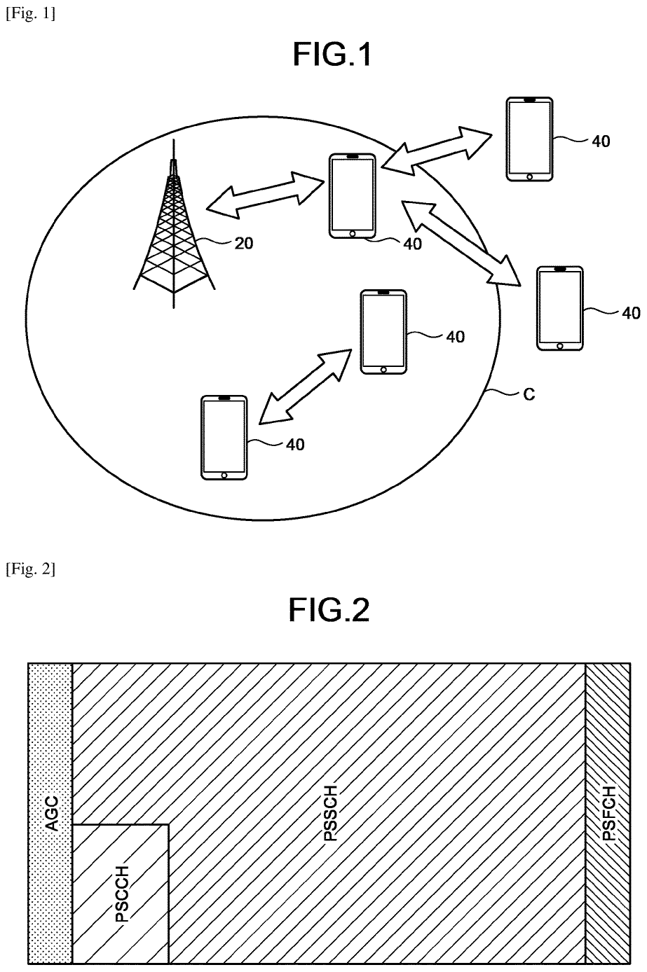

FIG. 1 is a diagram illustrating an overview of sidelink communication. Use cases of the sidelink communication are roughly divided into two. The first is a case where two or more terminal devices 40 are present inside a cell C configured by a base station 20. The second is a case where at least one of the two or more terminal devices 40 is present inside the cell C and the other terminal device 40 is present outside the cell C. At this time, the terminal device 40 present inside the cell C may perform communication with the base station 20 in addition to the sidelink communication. As a result, the terminal device 40 present inside the cell C functions as a relay station that relays the base station 20 and the terminal device 40 present outside the cell C.

Note that the presence of the terminal device 40 inside the cell C means that the terminal device 40 is in a state in which a quality of a downlink signal received from the base station 20 is equal to or higher than a predetermined standard. In other words, the presence of the terminal device 40 outside the cell C means that the terminal device 40 is in a state in which the quality of the downlink signal received from the base station 20 is equal to or lower than the predetermined standard.

In addition, the presence of the terminal device 40 inside the cell C means that the terminal device 40 is in a state in which a predetermined downlink channel received from the base station 20 can be decoded with a predetermined probability or higher. In other words, the presence of the terminal device 40 outside the cell C means that the terminal device 40 is in a state in which the predetermined downlink channel received from the base station 20 cannot be decoded with the predetermined probability or higher.

In the following description, the terminal device 40 that receives information regarding the sidelink communication from the base station 20 and transmits a sidelink control channel may be referred to as a transmission device (TxUE) 40T, and the other terminal device 40 may be referred to as a reception device (RxUE) 40R.

### 1-1-2. Details of Sidelink Communication

The sidelink communication is direct communication between the terminal devices 40 different from each other. In the sidelink communication, a resource pool is configured in the terminal device 40. The resource pool is a candidate for time and frequency resources used for sidelink transmission and reception. The terminal device 40 selects a resource for the sidelink transmission and reception from the resource pool and performs the sidelink communication.

Since the sidelink communication is performed using an uplink resource (uplink subframe or uplink component carrier), the resource pool is also configured in the uplink subframe or the uplink component carrier.

### Sidelink Physical Channel

A sidelink physical channel includes a physical sidelink control channel (PSCCH), a physical sidelink shared channel (PSSCH), a physical sidelink feedback channel (PSFCH), and the like.

Further, in the sidelink transmission, a symbol for automatic gain control (AGC) may be added in addition to a combination of these sidelink physical channels. The AGC can be used to recognize (adjust) a gain (amplitude) of the sidelink transmission on a reception side (for example, the reception device 40R) of the sidelink transmission. The symbol for the AGC can be generated by copying the immediately following symbol.

FIG. 2 is a diagram illustrating an example of mapping of the sidelink physical channel to a physical resource (time-frequency resource). In FIG. 2, a horizontal direction is a time direction, and a vertical direction is a frequency direction.

The PSCCH is used to transmit sidelink control information (SCI). Mapping of an information bit of the sidelink control information is defined as an SCI format. The sidelink control information includes a sidelink grant. The sidelink grant is used for PSSCH scheduling.

The PSSCH is used to transmit sidelink data (sidelink-shared channel (SL-SCH)). The PSSCH may also be used to transmit higher layer control information (e.g., medium access control (MAC)/radio resource control (RRC) signaling).

The PSFCH is used to response to the transmission terminal device with a HARQ response (ACK/NACK) for a PSSCH decoding result.

### Details of Sidelink Control Information

The sidelink control information can be transmitted while being divided into first SCI and second SCI by using two SCI formats. A format of the first SCI is a first SCI format (for example, an SCI format 1-A). A format of the second SCI is a second SCI format (for example, an SCI format 2-A, an SCI format 2-B, or an SCI format 2-C).

The first SCI is transmitted on the PSCCH. For example, the first SCI includes the following control information for scheduled sidelink transmission.
Information regarding priority
Information regarding frequency resource and time resource
Resource reservation period
Information regarding demodulation reference signal (DMRS)
Information regarding second SCI format
Information regarding modulation and coding scheme of PSSCH
Information regarding PSFCH
Information regarding conflict

The resource reservation period indicates a period of a resource that can be reserved for periodic sidelink communication.

The second SCI is transmitted on the PSSCH. That is, the second SCI is multiplexed on the SL-SCH and the PSSCH which are data of the sidelink communication and transmitted. For example, the second SCI includes the following control information for scheduled sidelink transmission.
Hybrid automatic repeat request (HARQ) process number
New data indicator
Redundancy version
Source ID
Destination ID
On/Off information of HARQ feedback
Information indicating cast type
CSI request

The new data indicator is information indicating whether or not the data (SL-SCH) of the HARQ process number is transmitted for the first time (first transmission). The redundancy version is information regarding an encoding bit in the data (SL-SCH) of the HARQ process number.

The source ID is information regarding the TxUE (transmission device 40T) and/or information for identifying the TxUE (transmission device 40T). The destination ID is information regarding the RxUE (reception device 40R) and/or information for identifying the RxUE (reception device 40R).

The information indicating the cast type is information indicating that the sidelink transmission is broadcast, groupcast, or unicast. The CSI request is trigger information for transmission of channel state information.

### Sidelink Resource Pool

In the sidelink, the resource pool (sidelink resource pool) is configured as a resource used for PSSCH transmission and reception.

In a frequency axis, the resource pool includes one or more consecutive subchannels. A subchannel includes one or more consecutive physical resource blocks (PRBs). The number of subchannels and the size of the subchannel are set by higher layer parameters.

A slot configured as the resource pool is indicated by a bitmap. Each bit of the bitmap corresponds to a slot that can be configured as the sidelink resource pool.

For example, in a case where a value of the bit indicates 1, the corresponding slot is configured as the resource pool, and in a case where the value of the bit indicates 0, the corresponding slot is not configured as the resource pool. The length of the bitmap is set by a higher layer.

A slot including S-SS/PSBCH blocks is not configured as the resource pool. A sidelink-synchronization signal (S-SS) is a signal used for synchronization in the sidelink communication. A physical sidelink broadcast channel (PSBCH) is a channel used for transmitting broadcast information (system information or the like) in the sidelink communication.

Further, a slot that does not semi-statically include a predetermined number of uplink symbols is not configured as the resource pool. In addition, a reserved slot is not configured as the resource pool.

The resource pool is configured from the base station 20 for the terminal device 40 by a system information block (SIB) or a dedicated RRC message. Alternatively, the resource pool is configured by information regarding the resource pool preset in the terminal device 40.

A time resource pool is indicated by period information, offset information, and subframe bitmap information. A frequency resource pool is indicated by a start position of a resource block, an end position of the resource block, and the number of consecutive resource blocks.

Note that a device for configuring the resource pool may be other than the base station 20. Examples of the device other than the base station 20 include a representative terminal device 40 (primary terminal device or master terminal device).

### Sidelink Resource Allocation Mode

In the sidelink, two sidelink resource allocation modes can be used.

In Sidelink Resource Allocation Mode 1, sidelink resource allocation is performed by a network (such as the base station 20). The TxUE (transmission device 40T) determines a sidelink transmission resource based on the control information (sidelink grant) from the network and performs the sidelink communication.

In Sidelink Resource Allocation Mode 2, the terminal device 40 (the TxUE or the like) determines the sidelink transmission resource from the sidelink resource pool.

The TxUE may perform sensing described below and determine the sidelink transmission resource.

### Sensing Method in Sidelink Communication

When Sidelink Resource Allocation Mode 2 is set, the transmission device 40T selects a sidelink resource from the configured resource pool according to a predetermined procedure. The predetermined procedure includes predetermined sensing. For example, the terminal device 40 performs predetermined sensing defined in advance, and selects the sidelink resource based on a result of the sensing.

In this manner, the sensing performed by the terminal device 40 to select the sidelink resource is referred to as sidelink sensing regarding the sidelink communication (hereinafter, also simply referred to as sidelink (SL) sensing). Details of the SL sensing are described in Chapter 8.1.4 of 3GPP TS 38.214.

As one of predetermined procedures for resource selection, the transmission device 40T receives the PSCCH transmitted from another terminal device 40 in the resource pool. The transmission device 40T grasps a resource allocation status (usage status) of the resource pool based on the SCI transmitted on the PSCCH.

Further, the transmission device 40T measures reference signal received power (RSRP) of a resource (a resource to which the PSSCH is allocated) scheduled by the SCI transmitted on the received PSCCH. If the measured RSRP is equal to or more than a predetermined value, the transmission device 40T excludes the resource from resources for resource selection, and selects a resource for the sidelink (SL) communication from the remaining resources.

For the RSRP measurement, PSCCH-RSRP and PSSCH-RSRP are defined, and the use of any one of the PSCCH-RSRP and the PSSCH-RSRP is configured by RRC signaling. The PSCCH-RSRP and the PSSCH-RSRP are respectively measured on the DMRSs of the PSCCH (and resources of the DMRSs of the PSSCH).

Note that the sensing is performed in units of predetermined frequency and time resources used in the sidelink communication. The predetermined frequency resource is a subchannel and includes one or more resource blocks. The predetermined time resource may be one or more slots. Additionally or alternatively, the predetermined time resource may be one or more symbols.

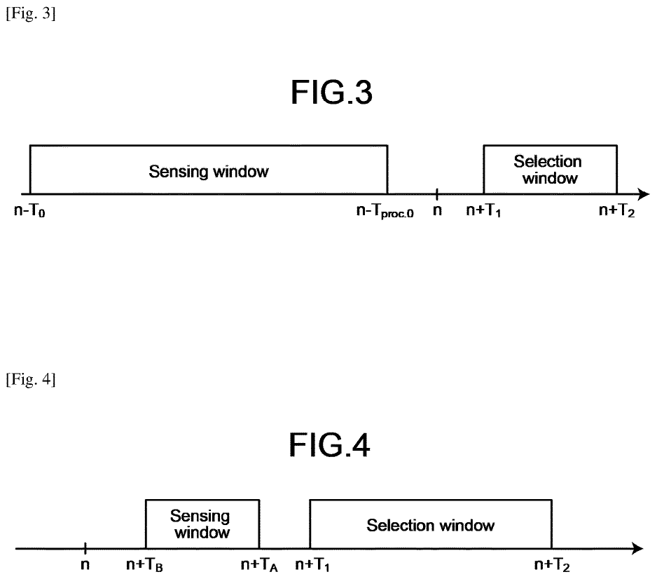

FIG. 3 is a diagram for describing an example of the SL sensing. The SL sensing method illustrated in FIG. 2 is particularly suitable (used) in a case where transmission data of the sidelink communication performed by another terminal device 40 is periodically generated traffic (periodic transmission).

This method is also referred to as full sensing. In the full sensing, the transmission device 40T configures a selection window (resource selection period or resource selection window) including a period from n+T₁ to n+T₂ when there is a trigger for resource selection at time n.

Furthermore, the transmission device 40T sets a sensing window (sensing period or resource sensing window) including a period from n-T₀ to n-T_{proc,0} when there is a trigger for resource selection at time n. Since the sensing window is a time before time n, the transmission device 40T performs sensing in advance.

Furthermore, in this method, the periodic transmission (periodic traffic) is assumed as described above. Therefore, a periodicity list of possible sidelink (SL) transmission is configured for the transmission device 40T by the RRC signaling. That is, the transmission device 40T can estimate the future resource usage status from the past resource usage status based on the periodicity.

Note that the “RRC signaling” described above or below means that one or more RRC parameters (information elements (IE)) are included in a predetermined RRC message (e.g., RRC Reconfiguration or RRC Setup) and transmitted.

In a case where the RRC message is transmitted in downlink, the RRC message is transmitted from the base station 20 (e.g., gNB) to the terminal device 40. In a case where the RRC message is transmitted in uplink, the RRC message is transmitted from the terminal device 40 to the base station 20. In a case where the RRC message is transmitted in sidelink, the RRC message is transmitted from the transmission device 40T to the reception device 40R.

Details of each parameter are as follows.

T₀={100,1100 [ms]}: This parameter indicates a start time point of the sensing window. This parameter is configured by the RRC signaling (RRC IE: sl-Sensing Window). Note that the unit of the parameter is millisecond, and the unit of the other parameters is slot.

T₁: This parameter takes a value equal to or more than 0 and equal to or less than T proc,1. The transmission device 40T selects T₁. T_{proc, 1} is a parameter corresponding to a processing time of the transmission device 40T and is defined according to a subcarrier spacing (SCS). For example, T_{proc, 1} satisfies T_{proc, 1}=3 for 15 kHz, 5 for 30 kHz, 9 for 60 kHz, and 17 for 120 kHz.

T₂: This parameter takes a value equal to or more than T₂ₘᵢₙ and equal to or less than a remaining packet delay budget of the transmission data. The transmission device 40T selects T₂. T₂ₘᵢₙ is configured by the RRC signaling (RRC IE: sl-Selection WindowList). Possible values of T₂ₘᵢₙ are {1, 5, 10, and 20}.

T_{proc, 0}=1 for 15 kHz, 1 for 30 kHz, 2 for 60 kHz, and 4 for 120 kHz: This parameter is a parameter corresponding to the processing time of the transmission device 40T, and is defined according to the subcarrier spacing.

### Procedure of Sidelink Sensing

In the transmission device 40T, in a case where there is a trigger for resource selection at time n, the transmission device 40T performs the following specific operation in the full sensing. Note that the following “configuration” is configuration performed inside the transmission device 40T.

(Step A1) The transmission device 40T defines (configures) the selection window. More specifically, a candidate single-slot resource R_{x,y} for transmission is defined as a set of consecutive subchannels LubCH with subchannels x+j in a slot t′_{y}^{SL}. Here, j represents the number of consecutive subchannels L_{subCH}. The transmission device 40T assumes that any set of consecutive subchannels L_{subCH} corresponds to one of the following three: a1) to a3).
a1) Any set of consecutive subchannels LsubCH included in a corresponding resource pool in a time interval [n+T₁,n+T₂] corresponds to one candidate single-slot resource for the UE (terminal device 40) that performs the full sensing.
a2) For the terminal device 40 that performs periodic-based partial sensing, any set of consecutive subchannels LsubCH included in a corresponding resource pool in a set of a plurality of candidate slots Y in the time interval [n+T₁,n+T₂] corresponds to one candidate single-slot resource for the terminal device 40 (Y satisfies Y>=Yₘᵢₙ (RRC IE: minNumCandidateSlots), and is selected by the terminal device 40).
a3) For the terminal device 40 that performs contiguous partial sensing in a case where a resource reservation interval P_{rsvp_Tx}=0, any set of consecutive subchannels L_{subCH} included in a corresponding resource pool in a set of a plurality of candidate slots Y′ in the time interval [n+T₁,n+T₂] corresponds to one candidate single-slot resource for the terminal device 40 (Y′ satisfies Y′>=Y′ₘᵢₙ, and is selected by the terminal device 40).

The total of the plurality of candidate single-slot resources is represented by Mₜₒₜₐₗ.

(Step A2) The transmission device 40T defines (configures) the sensing window. As described above, the sensing window is defined by a range of a plurality of slots represented by [n-T₀, T_{proc, 0}] ([n-T₀, T_{proc,0}^{SL}]) (in a case of the full sensing). Further, the transmission device 40T monitors (senses) the plurality of slots corresponding to the resource pool in the sensing window. However, the transmission device 40T does not have to monitor (sense) the slot transmitted by the transmission device 40T due to half-duplex restriction. In other words, the transmission device 40T monitors (senses) the plurality of slots corresponding to the resource pool in the sensing window except for the slot in which the transmission of the transmission device 40T is occurring.

A behavior of the transmission device 40T in the subsequent steps (step A3 and subsequent steps) is performed based on the RSRP measured in the plurality of slots and the PSCCH decoded in the plurality of slots. In a case where the terminal device 40 performs the periodic-based partial sensing, the terminal device 40 monitors a plurality of slots satisfying t_{y-kxP_reserve}^{SL}. Here, t_{y}^{SL} is one slot among the plurality of candidate slots selected above. In addition, monitoring (sensing) is performed based on decoding processing for the PSCCH from another terminal device 40 and RSRP measurement in these slots.

(Step A3) The transmission device 40T sets an RSRP threshold Th(pᵢ, pⱼ). The RSRP threshold is determined based on a parameter (RRC IE: sl-Thres-RSRP-List) notified by the base station 20, and is an independent value according to the priority of the transmission data. More specifically, a value corresponding to the RSRP threshold indicated by the i-th field in sl-Thres-RSRP-List is set as Th(pᵢ, pⱼ). Here, i=pᵢ+(pⱼ−1)*8.

(Step A4) The transmission device 40T initializes all the candidate resources in the selection window (the set of all the candidate single-slot resources) as a set S_{A}. Note that the candidate resource is a predetermined frequency and time resource unit used in the sidelink communication. In the following steps, the transmission device 40T excludes a resource corresponding to a predetermined condition from the set S_{A}.

(Step A5) The transmission device 40T excludes a resource (any candidate single-slot resource R_{x,y}) satisfying all of the following conditions b1) and b2) from the set SA.
b1) A slot t′ₘ^{SL} not sensed in (step A2).
b2) A slot that can be used for the sidelink transmission based on the periodicity list of the sidelink transmission (RRC IE: sl-ResourceReservePeriodList) and the decoded PSSCH (the SCI format 1-A received in the slot t′ₘ^{SL} and including a “Resource reservation period” field).

If the number of candidate single-slot resources R_{x,y} remaining in the set S_{A} is smaller than X*Mₜₒₜₐₗ, the set S_{A} returns to (step A4) and is initialized.

(Step A6) The transmission device 40T excludes a resource (any candidate single-slot resource R_{x,y}) satisfying all of the following conditions c1) to c3) from the set S_{A}.
c1) A resource indicated by the SCI transmitted from another terminal device 40 on the PSSCH. More specifically, the transmission device 40T receives the SCI format 1-A in the slot t′ₘ^{SL}, and the “Resource reservation period” field (only if present) and a “Priority” field in the received SCI format 1-A indicate P_{rsvp_Rx} and prio_{Rx}, respectively.
c2) By the RSRP measurement, a resource whose measured value is higher than a RSRP threshold Th(prioRx, priorx) set in (step A3).
c3) A slot that may be used for the sidelink transmission based on the periodicity list of the sidelink transmission and the decoded PSSCH.

(Step A7) In a case where the number of resources remaining in the set S_{A} is smaller than the predetermined value X*Mₜₒₜₐₗ obtained based on the parameter configured by the RRC signaling, the transmission device 40T increases the value Th(pᵢ, pⱼ) of the RSRP threshold by a predetermined value (3 dB) and performs the procedures again from (step A4).

(Step A8) The transmission device 40T randomly selects a resource for the sidelink transmission from the resources remaining in the set S_{A}.

The transmission device 40T performs the SL sensing by performing the above procedures (step A1) to (step A8).

In the full sensing described above, the transmission device 40T determines the sidelink resource to transmit the transmission data by using the past sensing results at a time point when the transmission data is generated. Therefore, the transmission device 40T always performs sensing processing.

For example, in a case where the transmission device 40T is a device driven by a small battery, such as a smartphone, it is not preferable to always perform the sensing processing from the viewpoint of power consumption. Therefore, partial sensing in which a part of the sensing window is reduced is standardized in order to reduce power consumption.

In the partial sensing, the transmission device 40T basically performs resource selection from sensed resources and does not perform resource selection from other resources. This sensing method is also called the periodic-based partial sensing (PBPS).

FIG. 4 is a diagram for describing another example of the SL sensing. The SL sensing method illustrated in FIG. 4 is particularly suitable (used) in a case where transmission data of the sidelink communication performed by another terminal device 40 is aperi-odically generated traffic (aperiodic transmission). This method is also called the contiguous partial sensing (CPS).

In the CPS, the transmission device 40T basically defines the sensing window immediately before the selection window and performs sensing. The sensing window in the CPS includes a period from n+T_{B} to n+T_{A}. T_{A} and T_{B} can each be a positive value, a negative value, or zero depending on the use case or situation. For example, T_{B} is a value determined based on the processing time and is T_{proc, 0}+T_{proc, 1}. For example, T_{A} is configured by the RRC signaling.

### Coordination between Terminal Devices 40 of Sidelink

In the sidelink communication, in order to reduce an SL transmission conflict, the reception device 40R or another terminal device 40 may notify the transmission device 40T of the control information (coordination information). That is, inter UE coordination (IUC) between the terminal devices 40 can be defined.

In the following description of the IUC, the reception device 40R or another terminal device is also referred to as an UE 40A, and the transmission device 40T is also referred to as an UE 40B.

In the IUC, the following two schemes are defined.

### IUC Scheme 1

In this scheme, the control information (coordination information) transmitted from the UE 40A to the UE 40B indicates resources (preferred resources) suitable for the transmission by the UE 40B or resources (non-preferred resources) not suitable for the transmission by the UE 40B. In other words, in this scheme, the control information (coordination information) transmitted from the UE 40A to the UE 40B may indicate resources suitable for reception by the UE 40A or resources not suitable for reception by the UE 40A.

### IUC Scheme 2

In this scheme, the control information (coordination information) transmitted from the UE 40A to the UE 40B indicates an expected resource conflict or potential resource conflict of the resource indicated by the sidelink control information of the UE 40B.

### Sidelink Cast Type

In the sidelink communication, the following three cast types are used. These cast types can be dynamically or semi-statically switched and used by the transmission device 40T. For example, the transmission device 40T transmits the sidelink control information (SCI) including the information indicating the cast type. As a result, the reception device 40R can recognize the cast type of the sidelink transmission (for example, the PSSCH).
Broadcast
Groupcast
Unicast

The broadcast is a method of performing simultaneous transmission toward all devices or unspecified devices within a communication area of the transmission device 40T. The groupcast is a method of performing transmission toward a device belonging to a specific group. The unicast is a method of performing transmission toward a specific device.

### 1-2. Reconfigurable Intelligent Surface (RIS)

The RIS may be used to control radio propagation. For example, the RIS is implemented by a surface that includes a number of small electronic control elements (antenna elements) that can alter a phase, amplitude, or reflection of incident waves.

Particularly, an advantage of using the RIS in a wireless communication system is that a communication coverage and communication capacity can be improved in an environment such as a city valley or in a building. By controlling the phase and amplitude of reflected waves by the RIS, the wireless communication system can direct a signal in a target direction or concentrate a signal at a specific location. Therefore, the wireless communication system can avoid an obstacle and improve a signal-to-interference and noise power ratio (SINR) in an area with a high interference level.

Also, as another advantage, the RIS can adapt a communication link to changing conditions of the communication environment. For example, in a case where the terminal device 40 is moving or the interference level is changing, the wireless communication system can improve the reliability and efficiency of the communication link by reconfiguring the RIS in real time.

In the 3GPP (registered trademark), a technology related to a repeater that can be controlled by a network (base station 20) (network-controlled repeater (NCR)) has been studied as a technology related to the RIS. Details thereof are described in NPL 2 described above.

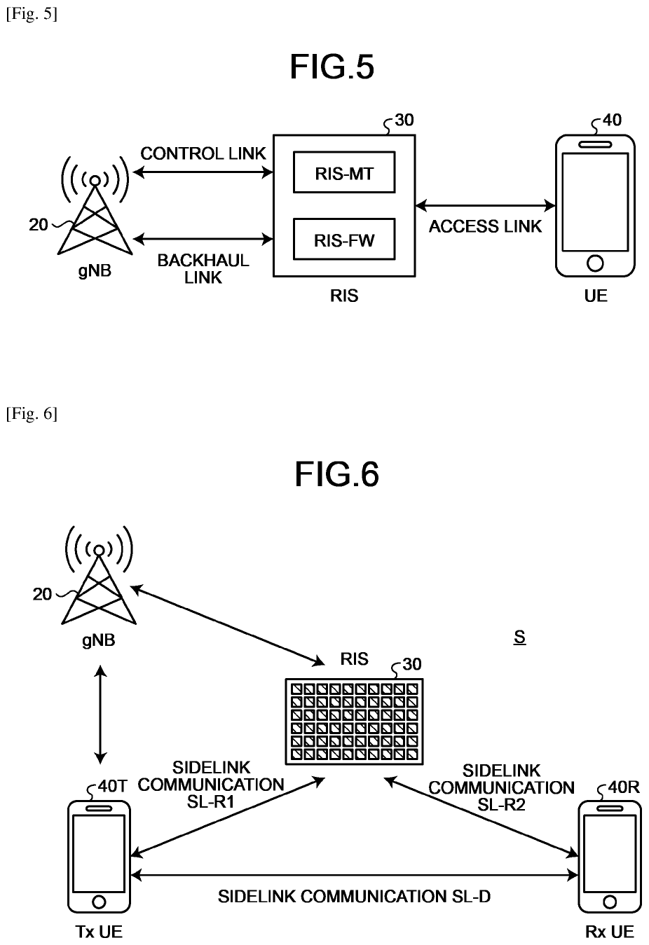

FIG. 5 is a diagram illustrating an example of the NCR. In FIG. 5, the NCR studied in the 3GPP (registered trademark) is described as an RIS 30.

As illustrated in FIG. 5, the RIS 30 includes RIS-mobile termination (MT) and RIS-forwarding (FW).

The RIS-MT is defined as a functional entity for communicating with the base station 20 through a control link (C-link) in order to transmit and receive the control information. The conventional control link is based on a Uu link (that is, downlink or uplink between the base station 20 and the terminal device 40).

The RIS-FW is defined as a functional entity for performing repetition (amplify-and-forwarding) of a downlink or uplink radio signal between the base station 20 and the terminal device 40 through a backhaul link and an access link. An operation of the RIS-FW may be controlled by the control information from the base station 20.

### 1-3. Overview of Proposed Technology

A radio propagation environment of the sidelink communication changes depending on whether or not there is a structure between the terminal devices 40 that perform the sidelink communication. In a case where there is no structure between the terminal devices 40, the radio propagation environment of the sidelink is a line-of-sight (LOS) environment. On the other hand, in a case where there is a structure between the terminal devices 40, the radio propagation environment of the sidelink is an NLOS environment.

Also in the sidelink communication, a communication quality in the NLOS environment is lower than that in the LOS environment. Therefore, in a case where the sidelink communication is in the NLO environment, the communication system of the proposed technology reduces deterioration of the communication quality through the RIS 30.

In particular, in the sidelink communication, it is assumed that the transmission device 40T and the reception device 40R are UEs and move. Therefore, it is important to control the RIS 30 under such an environment.

However, the conventional RIS 30 assumes downlink and uplink communication between the base station 20 and the terminal device 40, and it is assumed that only the base station 20 controls the RIS 30.

Therefore, in a conventional method for controlling the RIS 30, there is a possibility that suitable control cannot be performed in the sidelink communication.

Therefore, the present disclosure proposes a technology for performing the sidelink communication by using a relay device (for example, the RIS 30). Note that, here, the RIS 30 will be described as an example of the relay device that repeats a sidelink signal, but the relay device that repeats the sidelink signal is not limited to the RIS 30.

For example, the relay device (for example, the RIS 30) according to the proposed technology includes a relay unit. The relay unit transmits the sidelink signal transmitted from the transmission device 40T through a first link to the reception device 40R through a second link according to the control information. At least one of the base station 20, the transmission device 40T, the reception device 40R, or the communication device (for example, another terminal device 40) notifies of the control information.

Furthermore, for example, the relay device (for example, the RIS 30) according to the proposed technology includes an antenna unit. The antenna unit relays the sidelink communication performed between the transmission device 40T and the reception device 40R. The relay device transmits at least one of first information regarding a quality of communication with the transmission device 40T or a second information regarding a quality of communication with the reception device 40R to at least one of the transmission device 40T or the reception device 40R.

As a result, the communication system according to the proposed technology can perform the sidelink communication by using the relay device (for example, the RIS 30), and can suppress deterioration of the communication quality in the NLOS environment.

### 2. System Configuration

### 2-1. Example of Configuration of Communication System

FIG. 6 is a diagram illustrating a configuration example of a communication system S according to an embodiment of the present disclosure. The communication system S includes the base station 20, the Tx UE (the transmission device 40T), the Rx UE (the reception device 40R), and the RIS 30. Note that, although not illustrated in FIG. 6, the communication system S may include another terminal device 40.

In the communication system S, wireless communication devices included in the communication system S are operated in cooperation to provide a wireless network capable of mobile communication to a user. The wireless network of the present embodiment includes, for example, a radio access network and a core network.

Note that, in the present embodiment, the wireless communication device is a device having a wireless communication function, and corresponds to the base station 20, the transmission device 40T, the reception device 40R, and the RIS 30 in the example of FIG. 6. In the following description, the wireless communication device may be simply referred to as a communication device.

The communication system S may include a plurality of base stations 20, a plurality of transmission devices 40T, a plurality of reception devices 40R, and a plurality of RISs 30.

In the communication system S of FIG. 6, the sidelink communication can be performed. In the sidelink communication, direct communication from the transmission device 40T to the reception device 40R is performed. In the present embodiment, the direct communication (sidelink communication) is communication not via the base station 20, and includes communication via a communication node (for example, the RIS 30) other than the base station 20. Furthermore, in the communication system S of FIG. 6, the transmission device 40T, the reception device 40R, and/or the RIS 30 can perform downlink communication and/or uplink transmission with the base station 20 in addition to the sidelink communication.

In the present embodiment, the communication node other than the base station 20 may include various communication nodes such as a repeater and a UE relay (the terminal device 40) in addition to the RIS 30 described above. As described above, the present embodiment will be described assuming that the communication node is the RIS 30.

In the present embodiment, the direct communication not via the RIS 30 is referred to as sidelink communication SL-D. The direct communication via the RIS 30 is referred to as sidelink communication SL-R. In the sidelink communication SL-R, communication between the transmission device 40T and the RIS 30 will be referred to as sidelink communication SL-R1, and communication between the reception device 40R and the RIS 30 will be referred to as third sidelink communication SL-R2.

The sidelink communication SL-D may be suitable communication in a case where the transmission device 40T and the reception device 40R are in the LOS environment. The sidelink communication SL-R may be suitable communication in a case where the transmission device 40T and the reception device 40R are in the NLOS environment. Further, in the sidelink communication SL-R, it is desirable that the RIS 30 is optimally controlled according to the positions of the transmission device 40T and/or the reception device 40R.

The RIS 30 according to the present embodiment may include the RIS-MT and the RIS-FW similarly to the RIS 30 of FIG. 5.

Further, the RIS-MT according to the present embodiment is defined as a functional entity for communicating with the base station 20 and/or the terminal device 40 (the transmission device 40T, the reception device 40R, and another terminal device 40) through a control link in order to transmit and receive the control information. The control link in the present embodiment is based on the Uu link and/or the sidelink (PC5 link).

In addition, the RIS-FW according to the present embodiment is defined as a functional entity for performing repetition (amplify-and-forwarding) of a radio signal of the sidelink (sidelink communication SL-R) between the transmission device 40T and the reception device 40R through the backhaul link and the access link. The operation of the RIS-FW may be controlled by the control information from the base station 20 and/or the terminal device 40 (the transmission device 40T, the reception device 40R, and another terminal device 40).

The transmission device 40T can perform communication by switching between the sidelink communication SL-D and the sidelink communication SL-R based on a predetermined condition. The transmission device 40T can acquire the predetermined condition based on, for example, information (data, a signal, control Information, a trigger, or the like) transmitted by at least one of the base station 20, the RIS 30, the reception device 40R, or the other terminal device 40.

Note that the devices in the drawing may be considered as devices in a logical sense. That is, some devices in the drawing may be implemented by a virtual machine (VM), a container, a docker, or the like, and may be implemented on the physically same hardware.

Note that the terminal device 40 (the transmission device 40T and the reception device 40R) may support a radio access technology (RAT) such as long term evolution (LTE), new radio (NR), 6G in the 3GPP (registered trademark), Wi-Fi (registered trademark), or Bluetooth (registered trademark). At this time, the terminal device 40 may be configured to be able to use different radio access technologies (wireless communication schemes). For example, the terminal device 40 may be configured to be able to use NR and Wi-Fi.

Furthermore, the terminal device 40 may be configured to be able to use different cellular communication technologies (for example, the LTE, the NR, and the 6G). Each of the LTE, the NR, and the 6G is a type of cellular communication technology, and enables mobile communication of the terminal device 40 by arranging a plurality of areas covered by the base station 20 in a cell shape. Note that the radio access scheme used by the communication system S is not limited to LTE, NR, and 6G, and may be other radio access schemes such as wideband code division multiple access (W-CDMA) and code division multiple access 2000 (cdma 2000).

In the following description, the “LTE” includes LTE-Advanced (LTE-A), LTE-Advanced Pro (LTE-A Pro), and evolved universal terrestrial radio access (EUTRA). In addition, the NR includes New Radio Access Technology (NRAT), Further EUTRA (FEUTRA), NR-Advanced (NR-A), and NR-Advanced Pro (NR-A Pro). Note that a single base station 20 may manage a plurality of cells C. In the following description, the cell C corresponding to the LTE is referred to as an LTE cell, and the cell C corresponding to the NR is referred to as an NR cell.

The NR is a radio access technology of the next generation (fifth generation) of the LTE (fourth generation communication including LTE-Advanced and LTE-Advanced Pro). The NR is a radio access technology that can support various use cases including enhanced mobile broadband (eMBB), massive machine type communications (mMTC), and ultra-reliable and low latency communications (URLLC). The NR has been studied for a technical framework that addresses usage scenarios, requirements, arrangement scenarios, and the like in those use cases. In addition, the 6G (sixth generation) is a next-generation communication system (sixth generation communication system) for the LTE and the NR, and standards are being formulated by the 3GPP (registered trademark) or another standardization organization. In the 6G, various use cases assuming fusion with AI, sensing technology, computing resources, and the like have been studied in addition to the use cases assumed by the LTE and the NR. Note that, in the present specification, a name (for example, eNB or gNB) in the LTE and/or the NR will be used for description, but the name can be replaced with a name (for example, xNB) in the 6G.

Note that the terminal device 40 may be connectable to a network using a radio access technology (wireless communication scheme) other than the LTE, NR, 6G, Wi-Fi, and Bluetooth. For example, the terminal device 40 may be connectable to a network by using low power wide area (LPWA) communication. Furthermore, the terminal device 40 may be connectable to a network using a radio access technology of a proprietary standard.

Here, the LPWA communication is wireless communication that enables low-power wide-range communication. For example, the LPWA radio is Internet of Things (IOT) wireless communication using specified low power radio (for example, 920 MHz band) or an industry-science-medical (ISM) band. Note that the LPWA communication used by the terminal device 40 may conform to an LPWA standard. Examples of the LPWA standard include ELTRES, ZETA, SIGFOX, LoRaWAN, and NB-Iot. It is a matter of course that the LPWA standard is not limited thereto, and may be other LPWA standards.

One or more communication paths may include a virtual network. For example, the plurality of communication paths to which the terminal device 40 can be connected may include a virtual network such as a virtual local area network (VLAN) and a physical network such as an IP communication path. In this case, the terminal device 40 may perform route control based on a route control protocol such as open shortest path first (OSPF) or border gateway protocol (BGP).

In addition, the plurality of communication paths may include one or more overlay networks or may include one or more network slicings.

The base station 20 included in the communication system S may be a ground station or a non-ground station. The non-ground station may be a satellite station or an aircraft station. If the non-ground station is a satellite station, the communication system S may be a bent-pipe (transparent) type mobile satellite communication system.

In the present embodiment, the ground station (also referred to as the ground base station) refers to the base station 20 (including a relay station) installed on the ground. Here, the phrase “on the ground” not only means on the land, but also means in the ground, on the water, and underwater in a broad sense. Note that, in the following description, the term “ground station” may be replaced with “gateway”.

Note that the base station 20 in the LTE may be referred to as an evolved node B (eNodeB) or an eNB. Further, the base station 20 in the NR may be referred to as a gNodeB or a gNB. In the LTE and NR, the terminal device 40 (also referred to as a mobile station or a terminal) may be referred to as user equipment (UE). Note that the terminal device 40 is a type of communication device, and is also referred to as a mobile station or a terminal.

In the present embodiment, the concept of the communication device includes not only a portable mobile device (terminal device) such as a mobile terminal but also a device installed in a structure or mobile body. The structure or mobile body itself may be regarded as the communication device. In addition, the concept of the communication device includes not only the terminal device 40 but also the base station 20 and the relay station. The communication device is a type of processing device and information processing device. Furthermore, the communication device can be rephrased as a transmission device or a reception device.

Hereinafter, a configuration of each device included in the communication system S will be described in detail. Note that the configuration of each device described below is merely an example. The configuration of each device may be different from the following configuration.

### 2.2. Example of Configuration of Base Station

The base station 20 can be rephrased as a base station (BS) 20.

The base station 20 is a wireless communication device that performs wireless communication with the terminal device 40. The base station 20 may be configured to wirelessly communicate with the terminal device 40 via the relay station, or may be configured to directly wirelessly communicate with the terminal device 40.

The base station 20 is a type of communication device. More specifically, the base station 20 is, for example, a device corresponding to a wireless base station (node B, eNB, gNB, or the like) or a radio access point. The base station 20 may be a wireless relay station. Further, the base station 20 may be an optical feeder device called a remote radio head (RRH) or a radio unit (RU). The base station 20 may also be a reception station such as a field pickup unit (FPU). Furthermore, the base station 20 may be an integrated access and backhaul (IAB) donor node or IAB relay node that provides a radio access line and a radio backhaul line by time division multiplexing, frequency division multiplexing, or space division multiplexing.

Note that a radio access technology used by the base station 20 may be a cellular communication technology or wireless LAN technology. It is a matter of course that the radio access technology used by the base station 20 is not limited thereto, and may be another radio access technology. For example, the radio access technology used by the base station 20 may be a low power wide area (LPWA) communication technology. It is a matter of course that wireless communication used by the base station 20 may be wireless communication using millimeter waves. Further, the wireless communication used by the base station 20 may be wireless communication using radio waves or (optical) wireless communication using infrared rays or visible light. Further, the base station 20 may be capable of non-orthogonal multiple access (NOMA) communication with the terminal device 40. Here, the NOMA communication is communication (transmission, reception, or both) using a non-orthogonal resource. Note that the base station 20 may be capable of performing NOMA communication with another base station 20.

Note that the base stations 20 may be able to communicate with each other via a base station-core network interface (for example, NG Interface or S1 Interface). This interface may be either a wired interface or a wireless interface. Furthermore, the base stations may be able to communicate with each other via an inter-base station interface (for example, Xn Interface, X2 Interface, S1 Interface, or F1 Interface). This interface may be either a wired interface or a wireless interface.

Note that the concept of the base station includes not only a donor base station but also a relay base station (also referred to as a relay station). For example, the relay base station may be any one of an RF repeater, a smart repeater, and an intelligent surface. Further, the concept of the base station includes not only a structure having the function of the base station, but also a device installed in the structure.

The structure is, for example, a building such as a high-rise building, a house, a steel tower, a station facility, an airport facility, a port facility, an office building, a school building, a hospital, a factory, a commercial facility, or a stadium. Note that the concept of the structure includes not only a building, but also a non-building structure such as a tunnel, a bridge, a dam, a fence, or a steel column, or a facility such as a crane, a gate, or a windmill. In addition, the concept of the structure includes not only a structure on land (on the ground in a narrow sense) or in the ground, but also a structure on the water, such as a landing stage or Mega-Float, or a structure underwater such as an oceanographical observation facility. The base station can be rephrased as an information processing device.

The base station 20 may be a donor station or a relay station. Furthermore, the base station 20 may be a fixed station or a mobile station. The mobile station is a wireless communication device (for example, the base station) configured to be movable. Here, the base station 20 may be a device installed on a mobile body, or may be the mobile body itself. For example, a relay station having mobility can be regarded as the base station 20 as the mobile station. In addition, a device that originally has mobility, such as a vehicle, an unmanned aerial vehicle (UAV) typified by a drone, or a smartphone, and has the function of the base station (at least a part of the function of the base station) also corresponds to the base station 20 as the mobile station.

Here, the mobile body may be a mobile terminal such as a smartphone or a mobile phone. The mobile body may be a mobile body (for example, a vehicle such as an automobile, a bicycle, a bus, a truck, a motorcycle, a train, or a linear motor car) that moves on land (on the ground in a narrow sense), or may be a mobile body (for example, subway) that moves in the ground (for example, in a tunnel). Further, the mobile body may be a mobile body (for example, a vessel such as a passenger ship, a cargo ship, or a hovercraft) that moves on the water, or may be a mobile body (for example, a submersible boat such as a submersible, a submarine, or an unmanned underwater vehicle) that moves underwater. Note that the mobile body may be a mobile body that moves in the atmosphere (for example, an aircraft such as an airplane, an airship, or a drone).

Furthermore, the base station 20 may be a ground base station (ground station) installed on the ground. For example, the base station 20 may be a base station arranged in a structure on the ground, or may be a base station installed in a mobile body moving on the ground. More specifically, the base station 20 may be an antenna installed in a structure such as a building and a signal processing device connected to the antenna. It is a matter of course that the base station 20 may be a structure or a mobile body itself. The phrase “on the ground” not only means on land (on the ground in a narrow sense), but also means in the ground, on the water, and underwater in a broad sense. Note that the base station 20 is not limited to the ground base station. For example, in a case where the communication system S is a satellite communication system, the base station 20 may be an aircraft station. From the perspective of a satellite station, an aircraft station located on the earth is a ground station.

Note that the base station 20 is not limited to the ground station. The base station 20 may be a non-ground base station (non-ground station) capable of floating in the air or space. For example, the base station 20 may be an aircraft station or a satellite station.

The satellite station is a satellite station capable of floating outside the atmosphere. The satellite station may be a device mounted on a space mobile body such as an artificial satellite, or may be the space mobile body itself. The space mobile body is a mobile body that moves outside the atmosphere. Examples of the space mobile body include artificial bodies such as artificial satellites, spacecraft, space stations, and probes. A satellite that serves as the satellite station may be any one of a low earth orbiting (LEO) satellite, a medium earth orbiting (MEO) satellite, a geostationary earth orbiting (GEO) satellite, or a highly elliptical orbiting (HEO) satellite. It is a matter of course that the satellite station may be a device mounted on the LEO satellite, the MEO satellite, the GEO satellite, or the HEO satellite.

The aircraft station is a wireless communication device capable of floating in the atmosphere, such as an aircraft. The aircraft station may be a device mounted on an aircraft or the like, or may be the aircraft itself. Note that the concept of the aircraft includes not only a heavy aircraft such as an airplane or a glider, but also a light aircraft such as a balloon or an airship. Further, the concept of the aircraft includes not only the heavy aircraft and the light aircraft, but also a rotary-wing aircraft such as a helicopter or an autogyro. Note that the aircraft station (or the aircraft on which the aircraft station is mounted) may be an unmanned aircraft such as a drone.

Note that the concept of the unmanned aircraft also includes an unmanned aircraft system (UAS) and a tethered UAS. The concept of the unmanned aircraft also includes a Lighter than Air UAS (LTA) and a Heavier than Air UAS (HTA). In addition, the concept of the unmanned aircraft also includes high altitude UAS platforms (HAPs).

The size of the coverage of the base station 20 may be large like a macro cell or may be small like a picocell. It is a matter of course that the size of the coverage of the base station 20 may be extremely small like a femtocell. Further, the base station 20 may have a beamforming capability. In this case, the base station 20 may form a cell or a service area for each beam.

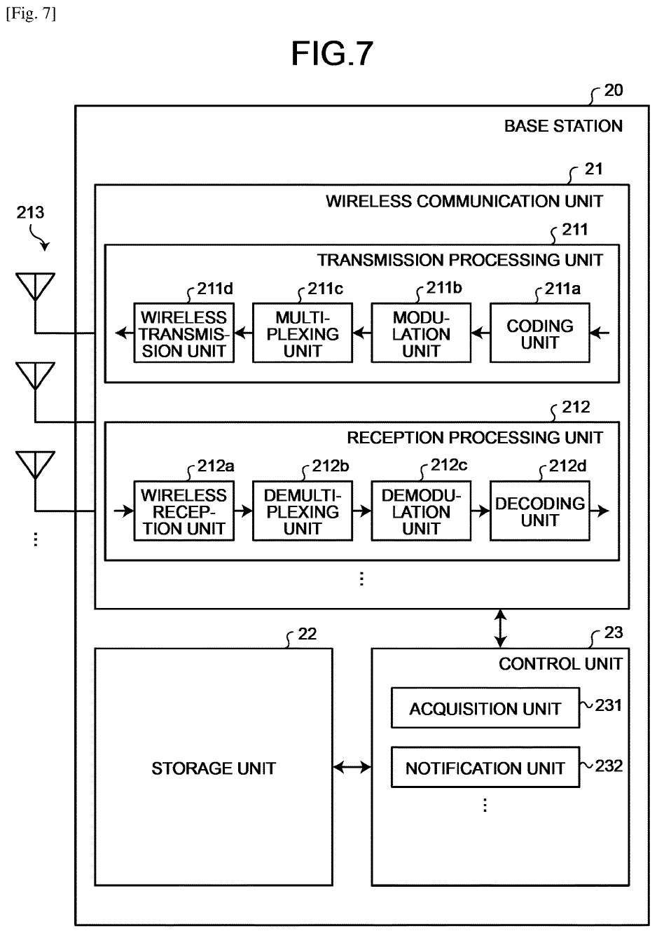

FIG. 7 is a diagram illustrating an example of a configuration of the base station 20 according to an embodiment of the present disclosure. The base station 20 includes a signal processing unit 21, a memory 22, and a control unit 23. Note that the configuration illustrated in FIG. 7 is a functional configuration, and a hardware configuration may be different from this. Further, the functions of the base station 20 may be distributed to and implemented in a plurality of physically separated components. Some or all of the base station 20 may be implemented in or using circuitry.

The signal processing unit 21 is a signal processing unit for wirelessly communicating with another wireless communication device (for example, the terminal device 40 or another base station 20). The signal processing unit 21 operates under the control of the control unit 23. The signal processing unit 21 supports one or more radio access schemes. For example, the signal processing unit 21 supports both the NR and the LTE. The signal processing unit 21 may support W-CDMA or cdma2000 in addition to the NR or the LTE. Furthermore, the signal processing unit 21 may support an automatic retransmission technology such as hybrid automatic repeat request (HARQ).

The signal processing unit 21 includes a transmission processing unit 211, a reception processing unit 212, and an antenna 213. The signal processing unit 21 may include a plurality of transmission processing units 211, a plurality of reception processing units 212, and a plurality of antennas 213. Note that, in a case where the signal processing unit 21 supports a plurality of radio access schemes, each unit of the signal processing unit 21 can be individually configured for each radio access scheme. For example, the transmission processing unit 211 and the reception processing unit 212 may be individually configured for each of the LTE and the NR. Furthermore, the antenna 213 may include a plurality of antenna elements (for example, a plurality of patch antennas). In this case, the signal processing unit 21 may be configured to be beamformable. The signal processing unit 21 may be configured to be able to perform polarization beamforming using vertically polarized waves (V-polarized waves) and horizontally polarized waves (H-polarized waves).

The transmission processing unit 211 performs transmission processing of downlink control information and downlink data. For example, the transmission processing unit 211 codes the downlink control information and the downlink data input from the control unit 23 by using a coding method such as block coding, convolutional coding, or turbo coding. Here, coding with a polar code and coding with a low density parity check code (LDPC code) may be performed. Then, the transmission processing unit 211 modulates the coded bit by a predetermined modulation scheme such as BPSK, QPSK, 16-QAM, 64-QAM, or 256-QAM. In this case, signal points on constellation do not necessarily have to be equidistant. The constellation may be non-uniform constellation (NUC). Then, the transmission processing unit 211 multiplexes a modulation symbol of each channel and a downlink reference signal, and maps them to a predetermined resource element. Then, the transmission processing unit 211 performs various types of signal processing on the multiplexed signal. For example, the transmission processing unit 211 performs processing such as conversion into the frequency domain by fast Fourier transform, addition of a guard interval (cyclic prefix), generation of a baseband digital signal, conversion into an analog signal, quadrature modulation, up-conversion, removal of extra frequency components, or power amplification. A signal generated by the transmission processing unit 211 is transmitted from the antenna 213.

The reception processing unit 212 processes an uplink signal received via the antenna 213. For example, the reception processing unit 212 performs, on the uplink signal, down-conversion, removal of an unnecessary frequency component, a control of an amplification level, quadrature demodulation, conversion into a digital signal, removal of a guard interval (cyclic prefix), extraction of a frequency domain signal by fast Fourier transform, and the like. Then, the reception processing unit 212 separates an uplink channel such as a physical uplink shared channel (PUSCH) or physical uplink control channel (PUCCH) and an uplink reference signal from a signal subjected to these processings. Further, the reception processing unit 212 performs demodulation of a reception signal for a modulation symbol of the uplink channel by using a modulation scheme such as binary phase shift keying (BPSK) or quadrature phase shift keying (QPSK). The modulation scheme used for the demodulation may be 16-quadrature amplitude modulation (QAM), 64-QAM, or 256-QAM. In this case, signal points on constellation do not necessarily have to be equidistant. The constellation may be non-uniform constellation (NUC). Then, the reception processing unit 212 performs decoding processing on a coded bit of the demodulated uplink channel. Decoded uplink data and uplink control information are output to the control unit 23.

The antenna 213 is an antenna device (antenna unit) that mutually converts a current and a radio wave. The antenna 213 may include one antenna element (for example, one patch antenna) or may include a plurality of antenna elements (for example, a plurality of patch antennas). In a case where the antenna 213 includes a plurality of antenna elements, the signal processing unit 21 may be configured to be beamformable. For example, the signal processing unit 21 may be configured to generate a directional beam by controlling the directivity of the radio signal using the plurality of antenna elements. Note that the antenna 213 may be a dual-polarized antenna. In a case where the antenna 213 is a dual-polarized antenna, the signal processing unit 21 may use vertically polarized waves (V-polarized waves) and horizontally polarized waves (H-polarized waves) in radio signal transmission. Then, the signal processing unit 21 may control the directivity of the radio signal transmitted using the vertically polarized waves and the horizontally polarized waves. Furthermore, the signal processing unit 21 may transmit and receive a spatially multiplexed signal via a plurality of layers including a plurality of antenna elements.

The memory 22 is a storage device, from which data can be read and in which data can be written, such as a DRAM, an SRAM, a flash memory, or a hard disk. The memory 22 functions as storage means of the base station 20.

The control unit 23 is a controller that controls each unit of the base station 20. The control unit 23 is implemented by, for example, a processor such as a CPU or an MPU. For example, the control unit 23 is implemented in a manner in which the processor executes various programs stored in the storage device inside the base station 20 by using a RAM or the like as a work area. Note that the control unit 23 may be implemented by an integrated circuit such as an ASIC or an FPGA. The CPU, the MPU, the ASIC, and the FPGA can all be regarded as the controller. Furthermore, the control unit 23 may be implemented by a GPU in addition to or instead of the CPU.

As illustrated in FIG. 7, the control unit 23 includes an acquisition unit 231 and a notification unit 232. Each block (the acquisition unit 231 and the notification unit 232) included in the control unit 23 is a functional block indicating a function of the control unit 23. These functional blocks may be software blocks or hardware blocks. For example, each of the above-described functional blocks may be one software module implemented by software (including a microprogram) or may be one circuit block on a semiconductor chip (die). It is a matter of course that each functional block may be one processor or one integrated circuit. The control unit 23 may be configured with a functional unit different from the above-described functional block. A method of configuring the functional block is arbitrary. The operation of each block of the control unit 23 may be the same as the operation of each block of a control unit 43 of the terminal device 40.

In the present embodiment, the base station 20 may include a set of a plurality of physical or logical devices. For example, in the present embodiment, the base station 20 may be distinguished into a plurality of devices such as a baseband unit (BBU) and a radio unit (RU). Then, the base station 20 may be interpreted as an assembly of the plurality of devices. In addition, the base station 20 may be either the BBU or the RU, or may be both. The BBU and the RU may be connected by a predetermined interface (for example, an enhanced common public radio interface (eCPRI)). The RU may be referred to as a remote radio unit (RRU) or a radio dot (RD). Furthermore, the RU may correspond to a gNB distributed unit (gNB-DU) described below. Further, the BBU may correspond to a gNB central unit (gNB-CU) described below. Alternatively, the RU may be a wireless device connected to the gNB-DU described below. The gNB-CU, the gNB-DU, and the RU connected to the gNB-DU may be configured to conform to an open radio access network (O-RAN). In addition, the RU may be a device integrally formed with an antenna. An antenna of the base station 20 (for example, the antenna integrally formed with the RU) may adopt an advanced antenna system and support MIMO (for example, full dimension (FD)-MIMO) or beamforming. Furthermore, the antenna included in the base station 20 may include, for example, 64 transmission antenna ports and 64 reception antenna ports.

In addition, the antenna mounted on the RU may be an antenna panel including one or more antenna elements, and the RU may be mounted with one or more antenna panels. For example, the RU may be mounted with two types of antenna panels including a horizontal polarization antenna panel and a vertical polarization antenna panel, or two types of antenna panels including a clockwise circular polarization antenna panel and a counterclockwise circular polarization antenna panel. In addition, the RU may form and control an independent beam for each antenna panel.

A plurality of base stations 20 may be connected to each other. One or more base stations 20 may be included in the radio access network (RAN). In this case, the base station 20 may be simply referred to as a RAN, a RAN node, an access network (AN), or an AN node. Note that the RAN in the LTE may be referred to as an enhanced universal terrestrial RAN (EUTRAN). In addition, the RAN in the NR may be referred to as an NGRAN. The RAN in the W-CDMA (UMTS) may be referred to as a UTRAN.

Note that the base station 20 in the LTE may be referred to as an evolved node B (eNodeB) or an eNB. At this time, the EUTRAN includes one or more eNodeBs (eNBs). Further, the base station 20 in the NR may be referred to as a gNodeB or a gNB. At this time, the NGRAN includes one or more gNBs. The EUTRAN may include a gNB (en-gNB) connected to the core network (EPC) in the communication system (EPS) of the LTE. Similarly, the NGRAN may include an ng-eNB connected to the core network 5GC in the 5G communication system (5GS).

In a case where the base station 20 is an eNB, a gNB, or the like, the base station 20 may be referred to as a 3GPP access. In addition, in a case where the base station 20 is a radio access point, the base station 20 may be referred to as a non-3GPP access. Furthermore, the base station 20 may be an optical feeder device called a remote radio head (RRH) or a radio unit (RU). In addition, in a case where the base station 20 is a gNB, the base station 20 may be a combination of the gNB-CU and the gNB-DU described above, or may be any of the gNB-CU and the gNB-DU.

Here, the gNB-CU hosts a plurality of higher layers (for example, radio resource control (RRC), service data adaptation protocol (SDAP), and packet data convergence protocol (PDCP)) in an access stratum for communication with the UE. On the other hand, the gNB-DU hosts a plurality of lower layers (for example, radio link control (RLC), medium access control (MAC), and physical layer (PHY)) in the access stratum. That is, among messages/information to be described later, the RRC signaling (semi-static notification) may be generated by the gNB-CU, whileMAC CE or DCI (dynamic notification) may be generated by the gNB-DU. Alternatively, in an RRC configuration (semi-static notification), for example, some configurations such as IE: cellGroupConfig may be generated by the gNB-DU, and the remaining configurations may be generated by the gNB-CU. These configurations may be transmitted and received through the F1 interface described below.

The base station 20 may be configured to be able to perform communication with another base station 20. For example, in a case where a plurality of base stations 20 are eNBs or a combination of eNBs and en-gNBs, the base stations 20 may be connected by the X2 interface. Further, in a case where a plurality of base stations 20 are gNBs or a combination of gn-eNBs and gNBs, the base stations 20 may be connected by the Xn interface. Further, in a case where a plurality of base stations 20 are a combination of gNB-CUs and gNB DUs, the base stations 20 may be connected by the F1 interface described above. A message/information (for example, RRC signaling, MAC control element (MAC CE), or DCI) to be described later may be transmitted among the plurality of base stations 20, for example, via the X2 interface, the Xn interface, or the F1 interface.

A cell provided by the base station 20 may be called a serving cell. The concept of the serving cell includes a primary cell (PCell) and a secondary cell (SCell). In a case where dual connectivity is configured for the UE (for example, the terminal device 40), the PCell and zero or one or more SCells provided by a master node (MN) may be referred to as a master cell group. Examples of the dual connectivity include EUTRA-EUTRA dual connectivity, EUTRA-NR dual connectivity (ENDC), EUTRA-NR dual connectivity with 5GC, NR-EUTRA dual connectivity (NEDC), and NR-NR dual connectivity.

The serving cell may include a primary secondary cell or a primary SCG Cell (PSCell). In a case where the dual connectivity is configured for the UE, the PSCell and zero or one or more SCells provided by a secondary node (SN) are referred to as a secondary cell group (SCG). Unless specially configured (for example, physical uplink control channel (PUCCH) on SCell), the PUCCH is transmitted by the PCell and the PSCell, not by the SCell. Radio link failure is detected in the PCell and the PSCell, and is not detected (does not have to be detected) in the SCell. Since the PCell and the PSCell have a special role in the serving cell as described above, they are also called special cells (SpCells).

One downlink component carrier and one uplink component carrier may be as-sociated with one cell. Further, a system bandwidth corresponding to one cell may be divided into a plurality of bandwidth parts (BWPs). In this case, one or more BWPs may be configured for the UE and one bandwidth part may be used for the UE as an active BWP. Further, radio resources (for example, a frequency band, numerology (subcarrier spacing), and slot configuration) that can be used by the terminal device 40 may be different for each cell, each component carrier, or each BWP.

### 2-3. Configuration of Terminal Device

The terminal device 40 can adopt any form of computer such as a mobile terminal, an imaging device, an M2M device, an IoT device, a wearable device, or an xR device.

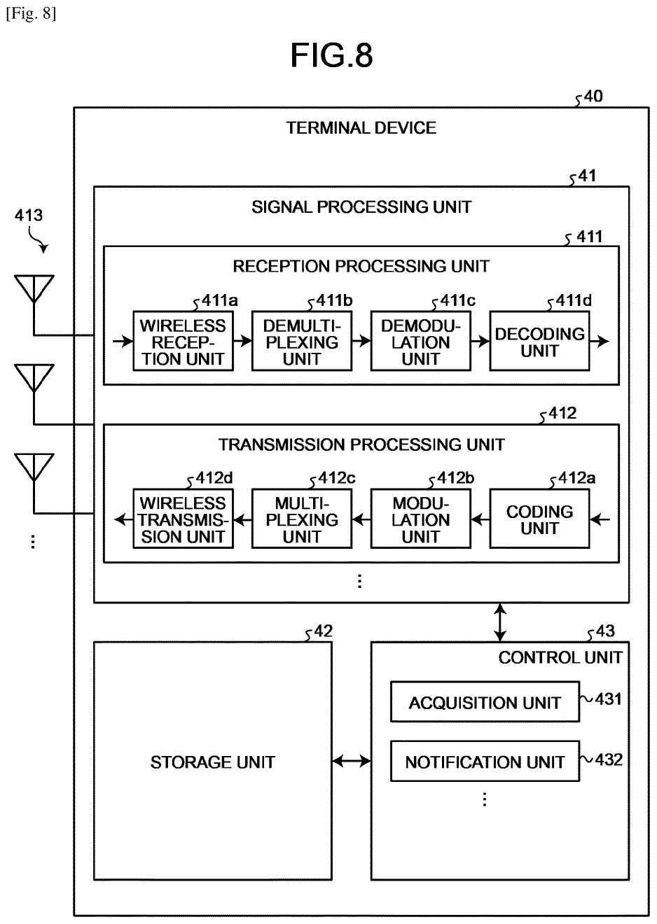

FIG. 8 is a diagram illustrating an example of the configuration of the terminal device 40 according to an embodiment of the present disclosure. The terminal device 40 includes a signal processing unit 41, a memory 42, and the control unit 43. Note that the configuration illustrated in FIG. 8 is a functional configuration, and a hardware configuration may be different from this. Further, the functions of the terminal device 40 may be distributed to and implemented in a plurality of physically separated components. Some or all of the terminal device 40 may be implemented in or using circuitry.

The signal processing unit 41 is a signal processing unit for wirelessly communicating with another wireless communication device (for example, the base station 20 and another terminal device 40). The signal processing unit 41 operates under the control of the control unit 43. The signal processing unit 41 includes a transmission processing unit 411, a reception processing unit 412, and an antenna 413. These components may be similar to the signal processing unit 21, the transmission processing unit 211, the reception processing unit 212, and the antenna 213 of the base station 20. Furthermore, similarly to the signal processing unit 21, the signal processing unit 41 may be configured to be beamformable. Furthermore, similarly to the signal processing unit 21, the signal processing unit 41 may be configured to be able to transmit and receive a spatially multiplexed signal.

The memory 42 is a storage device, from which data can be read and in which data can be written, such as a DRAM, an SRAM, a flash memory, or a hard disk. The memory 42 functions as storage means of the terminal device 40.

The control unit 43 is a controller that controls each unit of the terminal device 40. The control unit 43 is implemented by, for example, a processor such as a CPU or an MPU. For example, the control unit 43 is implemented in a manner in which the processor executes various programs stored in the storage device inside the terminal device 40 by using a RAM or the like as a work area. Note that the control unit 43 may be implemented by an integrated circuit such as an ASIC or an FPGA. The CPU, the MPU, the ASIC, and the FPGA can all be regarded as the controller. Furthermore, the control unit 43 may be implemented by a GPU in addition to or instead of the CPU.

As illustrated in FIG. 8, the control unit 43 includes an acquisition unit 431 and a notification unit 432. Each block (the acquisition unit 431 and the notification unit 432) included in the control unit 43 is a functional block indicating a function of the control unit 43. These functional blocks may be software blocks or hardware blocks. For example, each of the above-described functional blocks may be one software module implemented by software (including a microprogram) or may be one circuit block on a semiconductor chip (die). It is a matter of course that each functional block may be one processor or one integrated circuit. The control unit 43 may be configured with a functional unit different from the above-described functional block. A method of configuring the functional block is arbitrary. The operation of each block of the control unit 43 may be the same as the operation of each block of the control unit 23 of the base station 20.

### 2-4. Configuration of Relay Device

The RIS 30 can be rephrased as a relay device 30. The relay device 30 is a communication device that relays the sidelink communication between the terminal devices 40.

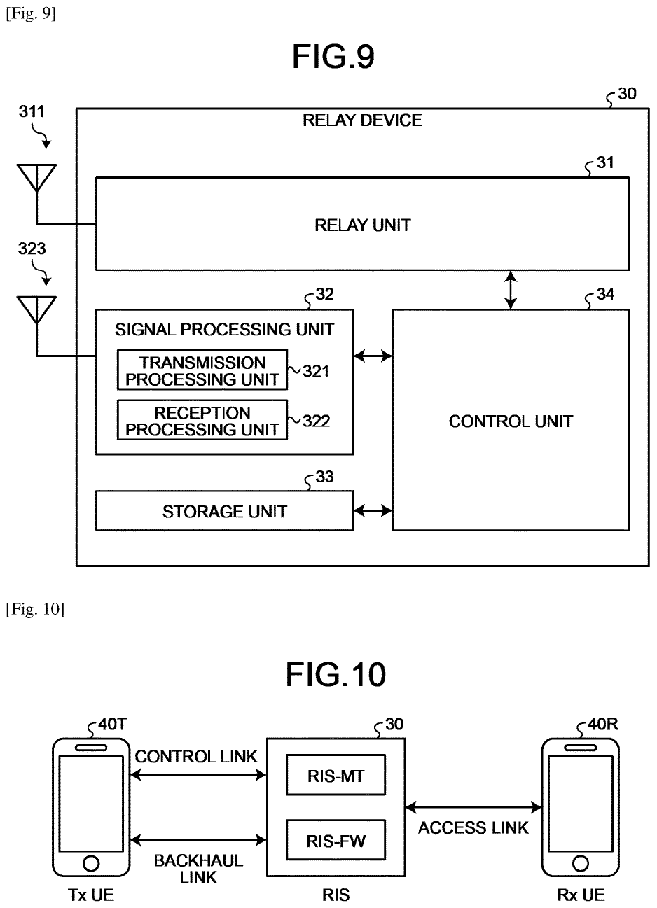

FIG. 9 is a diagram illustrating an example of a configuration of the relay device 30 according to an embodiment of the present disclosure. The relay device 30 includes a relay unit 31, a signal processing unit 32, a memory 33, and a control unit 34. Note that the configuration illustrated in FIG. 9 is a functional configuration, and a hardware configuration may be different from this. Further, the functions of the relay device 30 may be distributed to and implemented in a plurality of physically separated components. Some or all of the relay device 30 may be implemented in or using circuitry.

The relay unit 31 transmits the sidelink signal transmitted by the transmission device 40T to the reception device 40R. The relay unit 31 operates under the control of the control unit 34. The relay unit 31 includes an antenna unit 311.

The antenna unit 311 relays the sidelink communication SL-R performed between the transmission device 40T and the reception device 40R. The antenna unit 311 may include a plurality of antennas.

Although not illustrated, the relay unit 31 may include, for example, an amplifier or a phase shifter. For example, the relay unit 31 can amplify the sidelink signal transmitted by the transmission device 40T and transmit the sidelink signal to the reception device 40R. The relay unit 31 can be configured to be beamformable.

The signal processing unit 32 is a signal processing unit for wirelessly communicating with another wireless communication device (for example, the base station 20 and the terminal device 40). The signal processing unit 32 operates under the control of the control unit 34. The signal processing unit 32 includes a transmission processing unit 321, a reception processing unit 322, and an antenna unit 323. These components may be similar to the signal processing unit 21, the transmission processing unit 211, the reception processing unit 212, and the antenna 213 of the base station 20. Furthermore, similarly to the signal processing unit 21, the signal processing unit 32 may be configured to be beamformable. Furthermore, similarly to the signal processing unit 21, the signal processing unit 32 may be configured to be able to transmit and receive a spatially multiplexed signal.

Note that, in a case where the relay device 30 receives a signal (for example, a control signal) from another wireless communication device and does not transmit a signal to another wireless communication device, the transmission processing unit 321 can be omitted. Furthermore, in a case where the relay device 30 is configured to transmit and/or receive only a predetermined signal (for example, a control signal or a known signal), the transmission processing unit 321 and/or the reception processing unit 322 can be configured to only transmit and/or receive the predetermined signal.

In addition, at least some configurations and/or functions of the antenna units 311 and 323 may be shared. At least some configurations and/or functions of the relay unit 31 and the signal processing unit 32 may be shared.

The memory 33 is a storage device, from which data can be read and in which data can be written, such as a DRAM, an SRAM, a flash memory, or a hard disk. The memory 33 functions as storage means of the relay device 30.

The control unit 34 is a controller that controls each unit of the relay device 30. The control unit 34 is implemented by, for example, a processor such as a CPU or MPU. For example, the control unit 34 is implemented in a manner in which the processor executes various programs stored in the storage device inside the relay device 30 by using a RAM or the like as a work area. Note that the control unit 34 may be implemented by an integrated circuit such as an ASIC or FPGA. The CPU, the MPU, the ASIC, and the FPGA can all be regarded as the controller. Furthermore, the control unit 34 may be implemented by a GPU in addition to or instead of the CPU.

For example, the relay unit 31 is a functional block for implementing the RIS-FW. In addition, the signal processing unit 32 is a functional block for implementing the RIS-MT.

### 3. RIS Control Method

The RIS 30 of the communication system S relays the sidelink communication SL-R under the control of the communication node. Hereinafter, a method of controlling the RIS 30 for the communication node that controls the RIS 30 will be described.

### 3-1. Control by Transmission Device

FIG. 10 is a diagram for describing a first control method according to an embodiment of the present disclosure. Here, the transmission device 40T controls the RIS 30.

As illustrated in FIG. 10, the RIS 30 according to the present embodiment includes the RIS-MT and the RIS-FW. The RIS-MT of the RIS 30 is defined as a functional entity for communicating with the transmission device 40T through the control link in order to transmit and receive the control information.

The RIS-FW is defined as a functional entity for performing repetition (amplify-and-forwarding) of a sidelink radio signal between the transmission device 40T and the reception device 40R through the backhaul link and the access link. Here, an operation of the RIS-FW can be controlled by the control information from the transmission device 40T.

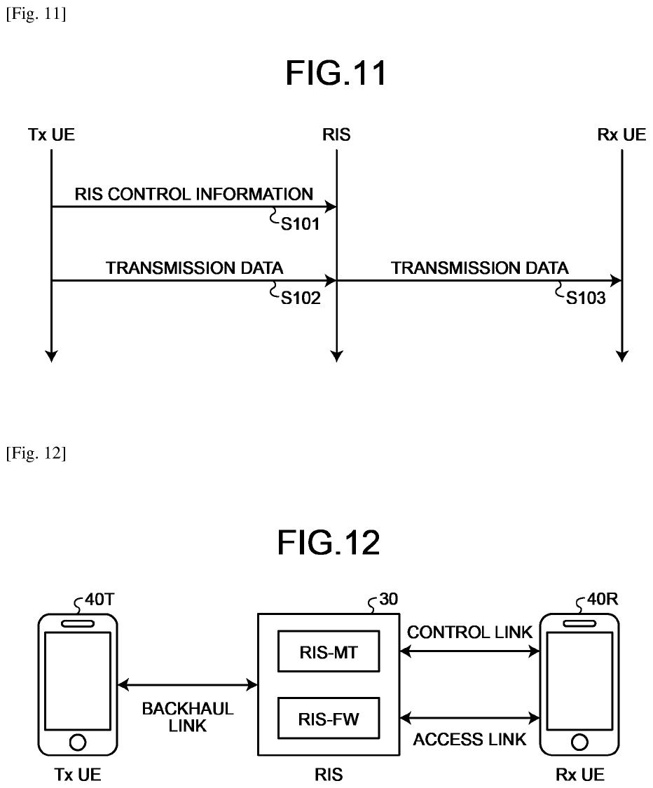

FIG. 11 is a sequence diagram illustrating an example of a flow of the first control method according to an embodiment of the present disclosure.

The transmission device 40T (Tx UE) transmits control information (hereinafter, also referred to as RIS control information) to the RIS 30 (RIS-MT) through the control link (step S101) and controls the RIS 30. The RIS control information may be transmitted using the PSCCH and/or PSSCH.

When the RIS control information is received by the RIS 30 (RIS-MT) from the transmission device 40T through the control link, the control of the RIS 30 is performed based on the RIS control information.

The transmission device 40T transmits transmission data for the reception device 40R (Rx UE) to the RIS 30 (step S102). The transmission device 40T transmits the transmission data through the backhaul link (see FIG. 10). The transmission data may be transmitted using the PSCCH and/or PSSCH.

As illustrated in FIG. 11, the RIS 30 (RIS-FW) transmits the transmission data received from the transmission device 40T to the reception device 40R (step S103). The RIS 30 repeats (relays or reflects) the transmission data received through the backhaul link, through the access link (see FIG. 10).

The first control method in which the transmission device 40T controls the RIS 30 is a suitable method, for example, in a case where the sidelink resource allocation mode is Sidelink Resource Allocation Mode 2. The first control method may be applied in a case where the transmission device 40T is in Sidelink Resource Allocation Mode 2. The first control method can also be applied to a case where the transmission device 40T is in Sidelink Resource Allocation Mode 1 and the RIS 30 is outside a coverage of a base station device (outside the communication area).

### 3-2. Control by Reception Device

FIG. 12 is a diagram for describing a second control method according to an embodiment of the present disclosure. Here, the reception device 40R controls the RIS 30.

As illustrated in FIG. 12, the RIS 30 according to the present embodiment includes the RIS-MT and the RIS-FW. The RIS-MT of the RIS 30 communicates with the reception device 40R through the control link in order to transmit and receive the control information. An operation of the RIS-FW of the RIS 30 can be controlled by the control information from the reception device ROR.

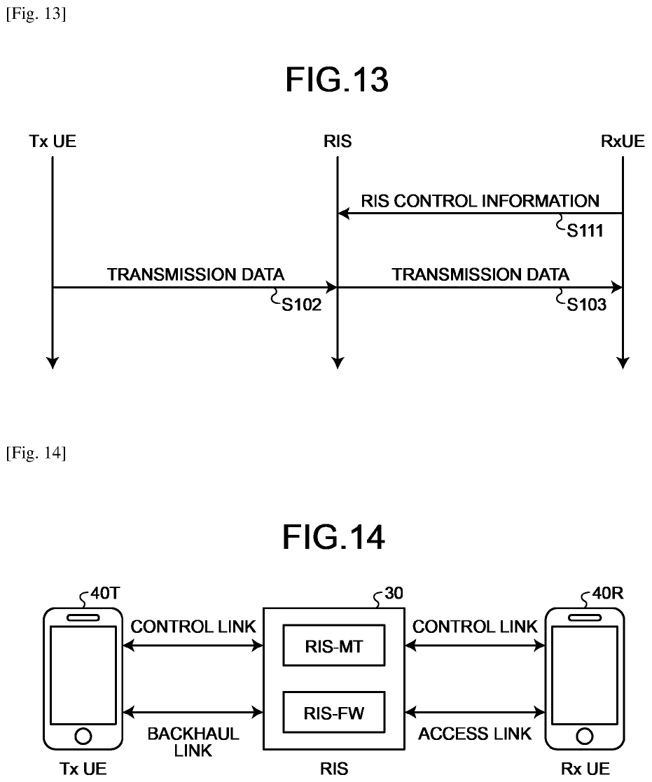

FIG. 13 is a sequence diagram illustrating an example of a flow of the second control method according to an embodiment of the present disclosure.

The reception device 40R (Rx UE) transmits the RIS control information to the RIS 30 (RIS-MT) through the control link (step S111), and controls the RIS 30. The RIS control information may be transmitted using the PSCCH and/or PSSCH.

When the RIS control information is received by the RIS 30 (RIS-MT) from the reception device 40R through the control link, the control of the RIS 30 is performed based on the RIS control information.

Since the following operation is the same as that in FIG. 11, a description thereof will be omitted.

The second control method in which the reception device 40R controls the RIS 30 is a suitable method, for example, in a case where the sidelink resource allocation mode is Sidelink Resource Allocation Mode 2. The second control method may be applied in a case where the transmission device 40T is in Sidelink Resource Allocation Mode 2. The second control method can also be applied to a case where the transmission device 40T is in Sidelink Resource Allocation Mode 1 and the RIS 30 is outside a coverage of a base station device (outside the communication area).

### 3-3. Control by Transmission Device and Reception Device

FIG. 14 is a diagram for describing a third control method according to an embodiment of the present disclosure. Here, both the transmission device 40T and the reception device 40R control the RIS 30.

As illustrated in FIG. 14, the RIS 30 according to the present embodiment includes the RIS-MT and the RIS-FW. The RIS-MT of the RIS 30 communicates with the transmission device 40T and the reception device 40R through the control link in order to transmit and receive the control information. The operation of the RIS-FW of the RIS 30 can be controlled by the control information from the transmission device 40T and the reception device ROR.

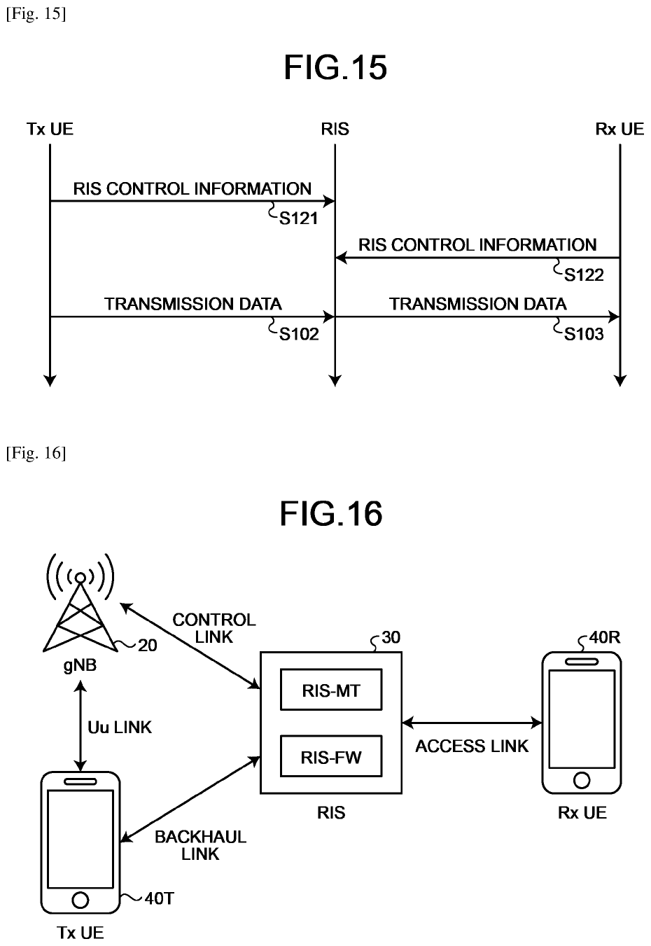

FIG. 15 is a sequence diagram illustrating an example of a flow of the third control method according to an embodiment of the present disclosure.

The transmission device 40T (Tx UE) transmits the RIS control information to the RIS 30 (RIS-MT) through the control link (step S121) and controls the RIS 30. The RIS control information may be transmitted using the PSCCH and/or PSSCH.

The reception device 40R (Rx UE) transmits the RIS control information to the RIS 30 (RIS-MT) through the control link (step S122), and controls the RIS 30. The RIS control information may be transmitted using the PSCCH and/or PSSCH.

When the RIS control information is received by the RIS 30 (RIS-MT) from the transmission device 40T and the reception device 40R through the control link, the control of the RIS 30 is performed based on the RIS control information.

Since the following operation is the same as that in FIG. 11, a description thereof will be omitted.

In the third control method, the control of the RIS 30 performed by the transmission device 40T and the control of the RIS 30 performed by the reception device 40R may be different from each other. For example, the transmission device 40T performs on/off control of the RIS 30. On the other hand, the reception device 40R performs beam control of the RIS 30.

Furthermore, in the third control method, the control of the RIS 30 performed by the transmission device 40T and the control of the RIS 30 performed by the reception device 40R may be the same as each other. In this case, priority (priority of the RIS control information) for the RIS control of the transmission device 40T or the reception device 40R may be set or defined in advance. The RIS 30 controls the RIS 30 based on the RIS control information with high priority.

Alternatively, the RIS 30 may control the RIS 30 based on the latest RIS control information. When the RIS control information is newly received from the transmission device 40T or the reception device 40R, the RIS 30 discards the old RIS control information and controls the RIS 30 based on the newly received RIS control information.

The third control method in which the transmission device 40T and the reception device 40R control the RIS 30 is a suitable method, for example, in a case where the sidelink resource allocation mode is Sidelink Resource Allocation Mode 2. The third control method may be applied in a case where the transmission device 40T is in Sidelink Resource Allocation Mode 2. The third control method can also be applied to a case where the transmission device 40T is in Sidelink Resource Allocation Mode 1 and the RIS 30 is outside a coverage of a base station device (outside the communication area).

### 3-4. Control by Base Station

FIG. 16 is a diagram for describing a fourth control method according to an embodiment of the present disclosure. Here, the base station 20 controls the RIS 30.

As illustrated in FIG. 16, the RIS 30 according to the present embodiment includes the RIS-MT and the RIS-FW. The RIS-MT of the RIS 30 communicates with the base station 20 (gNB) through the control link in order to transmit and receive the control information. The operation of the RIS-FW of the RIS 30 may be controlled by the control information from the base station 20.

Further, the transmission device 40T communicates with the base station 20 through the Uu link in order to transmit and receive the control information related to the sidelink communication.

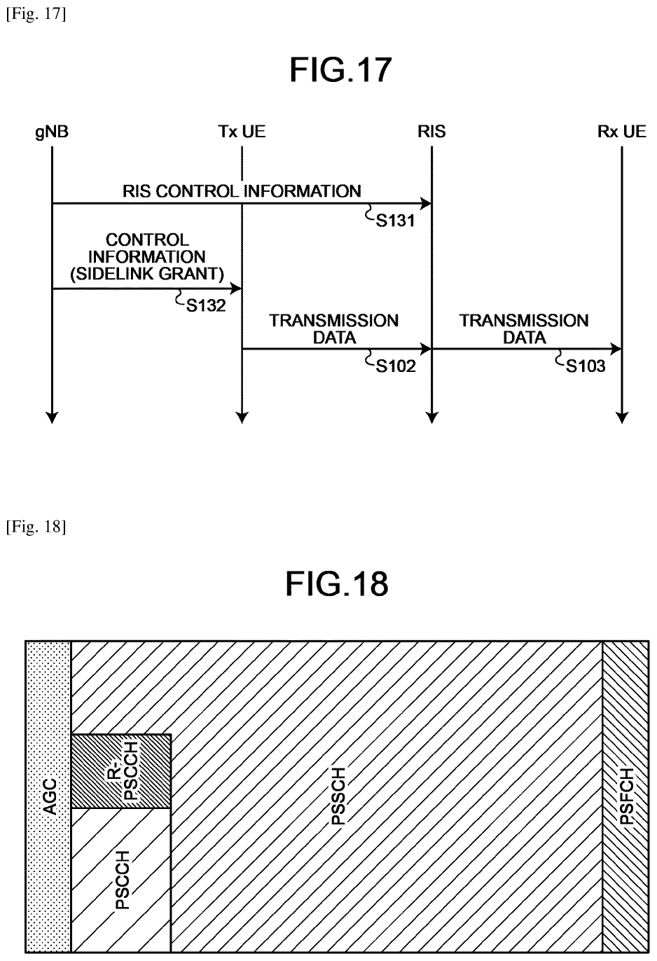

FIG. 17 is a sequence diagram illustrating an example of a flow of the fourth control method according to an embodiment of the present disclosure.

The base station 20 (gNB) transmits the RIS control information to the RIS 30 (RIS-MT) through the control link (step S131), and controls the RIS 30. The RIS control information may be transmitted using the PDCCH and/or PDSCH.

When the RIS control information is received by the RIS 30 (RIS-MT) from the reception device 40R through the control link, the control of the RIS 30 is performed based on the RIS control information.

The base station 20 transmits the control information (sidelink grant) related to the sidelink communication to the transmission device 40T (step S132). The transmission device 40T performs the sidelink communication based on the sidelink grant received via the Uu link (downlink). The sidelink grant may be transmitted using the PDCCH.

Since the following operation is the same as that in FIG. 11, a description thereof will be omitted.

The fourth control method in which the base station 20 controls the RIS 30 is a suitable method, for example, in a case where the sidelink resource allocation mode is Sidelink Resource Allocation Mode 1. The fourth control method may be applied in a case where the transmission device 40T is in Sidelink Resource Allocation Mode 1.

The fourth control method can also be applied to a case where the transmission device 40T is in Sidelink Resource Allocation Mode 2 and the RIS 30 is within the coverage of the base station device (within the communication area).

In the fourth control method, the base station 20 controls the RIS 30, but the communication node that controls the RIS 30 is not limited to the base station 20. For example, instead of the base station 20, another terminal device 40 (for example, a primary terminal device or a master terminal device) may transmit the RIS control information to the RIS 30. The RIS control information may be transmitted using the PSCCH and/or PSSCH.

### 3-5. Pre-configuration of RIS

In the sidelink communication, predetermined control information may be pre-configured in such a way that communication between the terminal devices 40 can be performed even in a case where the terminal device 40 is outside the communication area of the base station 20 (out-of-coverage).

In the present embodiment, the predetermined control information can be pre-configured in such a way that communication can be performed between the terminal devices 40 even in a case where the RIS 30 is outside the communication area of the base station 20 (out-of-coverage).

For example, in a case where the RIS 30 is outside the coverage of the base station 20 and controlled by the terminal device 40 (the transmission device 40T, the reception device 40R, and/or another terminal device 40), the RIS 30 cannot receive the RRC signaling from the base station 20. Therefore, the RIS 30 uses the pre-configured RIS control information.

In this case, the RIS control information pre-configured in the RIS 30 can be configured (overwritten or updated) by the terminal device 40 (the transmission device 40T, the reception device 40R, and/or another terminal device 40). For example, in a case where a certain terminal device 40 performs the sidelink communication through the RIS 30, the terminal device 40 may notify the RIS 30 of the control information.

In a case where the RIS control information is configured by the terminal device 40, the RIS control information can be configured (notified) by the base station 20. For example, the terminal device 40 notifies the RIS 30 of the RIS control information received from the base station 20. In this manner, the RIS control information can be configured by the base station 20 via the terminal device 40.

In a case where the base station 20 described above controls the RIS 30, the RIS control information may be configured by the base station 20. Alternatively, even in a case where the RIS 30 is within the coverage of the base station 20 but is controlled by the terminal device 40, the RIS control information may be configured by the base station 20.

For example, in a case where the RIS 30 can receive the RRC signaling from the base station 20, the RIS 30 may use the RIS control information configured by the base station 20 without using the pre-configured RIS control information.

In addition, predetermined RIS control information (the above-described RIS control information) may include all or some of the control information in the RIS 30 described in the present embodiment. For example, the RIS control information may include control information related to beamforming in the sidelink communication, control information related to on/off control in the sidelink communication, and control information related to power control in the sidelink communication.

### 4. Control Example of RIS

Hereinafter, a control example of the RIS 30 will be described.

### 4-1. Beamforming

In the present embodiment, various methods can be used for beam control in the sidelink communication. For example, a method of dynamically performing the beam control by using physical layer signaling such as the PDCCH or PSCCH and a method of semi-statically performing the beam control by using the RRC or MAC signaling can be used for the beam control.

As first beam control, for example, the RIS 30 controls a reception beam used in the backhaul link from the transmission device 40T and/or a transmission beam used in the access link toward the reception device 40R.

A control method for the reception beam and a control method for the transmission beam may be individually performed. For example, the control of the reception beam in the RIS 30 may be performed semi-statically using the RRC or MAC signaling, and the control of the transmission beam in the RIS 30 may be performed dynamically using the physical layer signaling.

Furthermore, for example, the reception beam in the RIS 30 may be dynamically controlled using the physical layer signaling, and the transmission beam in the RIS 30 may be semi-statically controlled using the RRC or MAC signaling.

As second beam control, the RIS 30 controls weighting (phase rotation) of the antenna element (for example, the antenna unit 311) of the RIS 30. For example, the RIS 30 controls reflection for the backhaul link from the transmission device 40T and the access link toward the reception device 40R.

As third beam control, the RIS 30 controls an incident secondary modulation scheme. Here, the secondary modulation scheme is distribution in power and frequency bands.

### 4-2. On/Off Control of Repetition

The on/off control in the sidelink communication according to the present embodiment includes control of operations in an on state and an off state of the RIS 30 (RIS-FW).

Here, the on state of the RIS 30 is a state in which a portion (module or device) related to the RIS-FW of the RIS 30 is operable. For example, in a case where the RIS 30 is in the on state, the antenna element of the RIS 30 is energized.

The off state of the RIS 30 is a state in which the portion (module or device) related to the RIS-FW of the RIS 30 does not operate. For example, in a case where the RIS 30 is in the off state, the antenna element of the RIS 30 is not energized.

For example, the RIS 30 (RIS-FW) is always in the off state, and in a case where a notification of the on state is made by the RIS control information, the RIS 30 shifts (switches) to the on state.

Alternatively, for example, the RIS 30 (RIS-FW) is always in the on state, and in a case where a notification of the off state is made by the RIS control information, the RIS 30 shifts (switches) to the off state.

In addition, the on state or the off state may be explicitly notified (controlled) by the RIS control information. For example, the RIS control information includes 1-bit state information indicating the state of the RIS 30. In a case where the RIS 30 is in the on state, the state information is “1”. On the other hand, in a case where the RIS 30 is in the off state, the state information is “0”.

Further, for example, the RIS control information includes 1-bit trigger information. For example, in a case where the trigger information of the RIS control information is “1”, the RIS 30 switches the on state or the off state. On the other hand, in a case where the trigger information of the RIS control information is “0”, the RIS 30 does not switch the on state or the off state and maintains the current state.

In addition, the notification of the on state or the off state may be implicitly made in association with other control information. For example, the notification of the on state or the off state is made based on a notification of another RIS control (for example, the beam control).

Specifically, in a case where another RIS control is performed based on the RIS control information, the state of the RIS 30 becomes the on state. In other words, in a case where another RIS control is not performed based on the RIS control information, the state of the RIS 30 becomes the off state.

The RIS control information for the on/off control may include information explicitly or implicitly indicating at least one of the following pieces of information.
Time resource in on state or off state
Frequency resource in on state or off state
Spatial resource in on state or off state

Information regarding the time resource in the on state or the off state includes a time, a slot number, a frame number, and the like in which the RIS 30 is in the on or off state. Information regarding the frequency resource in the on state or the off state includes a resource block number, a subchannel number, a resource pool number, and the like. Information regarding the spatial resource in the on state or the off state includes a beam, a multiple input multiple output (MIMO) layer, a transmitting antenna, a receiving antenna, and the like.

### 4-3. Power Control of Repetition

Power control in the sidelink communication according to the present embodiment includes control of received power on the backhaul link and/or transmitted power on the access link in the RIS 30 (RIS-FW).

### First Power Control

In an example of first power control, the RIS 30 controls the transmitted power on the access link based on the received power on the backhaul link and/or the RIS control information.

For example, the RIS control information includes control information related to the transmitted power on the access link. For example, the RIS control information includes transmitted power information that explicitly or implicitly indicates the transmitted power on the access link. The RIS 30 determines the transmitted power on the access link based on the transmitted power information, and outputs transmission data from the backhaul link to the access link.

Alternatively, for example, the RIS control information includes control information for determining the transmitted power on the access link relative to the received power on the backhaul link. The RIS 30 determines the transmitted power on the access link based on the relative control information and the received power on the backhaul link, and outputs the transmission data from the backhaul link to the access link.

Specifically, in the RIS 30, in a case where the received power on the backhaul link is 2 watts and its relative control information indicates 0.5, the transmitted power on the access link is determined to be 1 watt.

### Second Power Control

In an example of second power control, the transmitted power on the access link is determined based on a path loss (a distance, a communication quality, or the like) between the RIS 30 and the reception device 40R and/or the RIS control information.

For example, information regarding the transmitted power determined according to the path loss is configured for (notified to) the RIS 30 by the RIS control information. Next, the RIS 30 acquires the path loss between the RIS 30 and the reception device 40R in the access link. The RIS 30 determines the transmitted power on the access link based on the path loss and the RIS control information.

As will be described later, the RIS 30 can acquire the path loss based on a reference signal transmitted from the reception device 40R, or can acquire the path loss through the control link or the like. As such, the RIS 30 may obtain the path loss by using various methods.

### Third Power Control

In an example of third power control, the transmitted power on the access link output from the RIS 30 may be limited to be equal to or less than the received power on the backhaul link. In other words, the transmitted power on the access link output from the RIS 30 is controlled within a range not exceeding the received power on the backhaul link.

In particular, the example of the third power control is suitable in a case where it is not recognized that the transmitted power on the access link output from the RIS 30 exceeds the received power on the backhaul link by a law or the like.

In a case where it is recognized by a law or the like that the transmitted power on the access link output from the RIS 30 exceeds the received power on the backhaul link, the transmitted power may be configured to exceed the received power on the backhaul link.

In this case, permission information that permits the transmitted power on the access link to exceed the received power on the backhaul link is configured in the RIS 30 in advance, or the permission information is received.

### 5. Example of Transmission of RIS Control Information

### 5-1. Dedicated Control Channel and Dedicated Control Format

Here, a case where the RIS control information is notified through a control channel and a control format dedicated to the RIS 30 will be described.

In a case where the base station 20 notifies of the RIS control information, the RIS-dedicated control channel and/or control format may be transmitted to one predetermined RIS 30. Alternatively, the RIS-dedicated control channel and/or control format may be transmitted to a plurality of predetermined RISs 30 (predetermined RIS group).

The RIS-dedicated control channel may be defined as a downlink control channel different from the conventional downlink control channel such as the PDCCH/PDSCH. The base station 20 notifies of the RIS control information by using the DCI addressed to the RIS 30. The control information includes information (for example, the cast type) related to the sidelink communication between the transmission device 40T and the reception device 40R.

In addition, the RIS-dedicated control format may be defined as a downlink control information format (DCI format) different from the conventional DCI format.

In a case where the terminal device 40 (the transmission device 40T, the reception device 40R, or another terminal device 40) notifies of the RIS control information, the RIS-dedicated control channel and/or control format may be transmitted to one predetermined RIS 30. Alternatively, the RIS-dedicated control channel and/or control format may be transmitted to a plurality of predetermined RISs 30 (predetermined RIS group).

### First Example of Dedicated Control Channel

The RIS-dedicated control channel may be defined as a sidelink control channel different from the conventional sidelink control channel such as the PSCCH/PSSCH. For example, the transmission device 40T transmits the PSCCH and the PSSCH for the reception device 40R and the RIS-dedicated control channel for the RIS 30.

FIG. 18 is a diagram illustrating a first example of mapping of the dedicated control channel according to an embodiment of the present disclosure. In this example, the RIS-dedicated control channel (described as R-PSCCH in FIG. 18,) may be mapped to be multiplexed (adjacent in the example of FIG. 18) in the frequency direction with the conventional PSCCH.

In the example of FIG. 18, the number of symbols of the RIS-dedicated control channel (that is, a time resource of the RIS-dedicated control channel) is the same as the number of symbols of the conventional PSCCH. In this case, the number of symbols of the RIS-dedicated control channel is determined based on control information for configuring the number of symbols of the conventional PSCCH.

In addition, the number of resource blocks of the RIS-dedicated control channel (that is, a frequency resource of the RIS-dedicated control channel) can be configured independently of the number of symbols of the conventional PSCCH.

In addition, a start position (a resource block serving as a start block) of the RIS-dedicated control channel in the frequency direction is determined based on the conventional PSCCH. For example, the start position of the RIS-dedicated control channel in the frequency direction is the next resource block to the last resource block of the conventional PSCCH.

### Second Example of Dedicated Control Channel

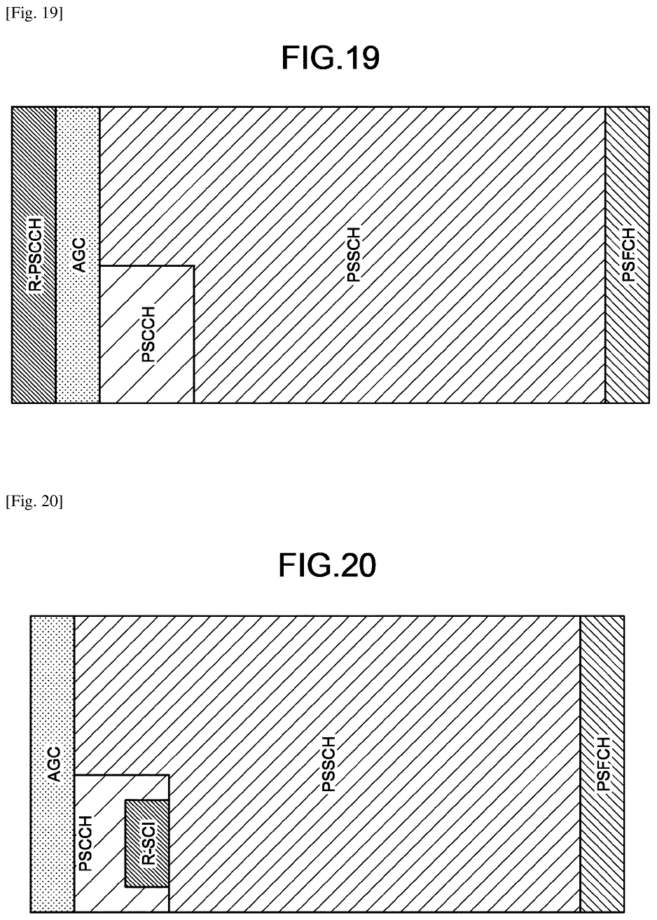

FIG. 19 is a diagram illustrating a second example of the mapping of the dedicated control channel according to an embodiment of the present disclosure. In this example, the RIS-dedicated control channel (described as R-PSCCH in FIG. 19) may be mapped to be multiplexed (for example, adjacent) in the time direction with the conventional PSCCH.

In the example of FIG. 19, the RIS-dedicated control channel is mapped to a symbol prior to an automatic gain control (AGC) symbol (prior to the first symbol of the PSSCH and/or PSCCH).

For example, the RIS-dedicated control channel is mapped to a symbol prior to the AGC symbol. For example, the RIS-dedicated control channel is mapped to a symbol two positions prior to the first symbol of the PSSCH and/or PSCCH.

In FIG. 19, the RIS-dedicated control channel is mapped to a symbol prior to the first symbol of the PSSCH and/or PSCCH, but the mapping of the control channel is not limited thereto.

For example, the RIS-dedicated control channel may be mapped to a symbol after the last symbol of the PSSCH. For example, the RIS-dedicated control channel is mapped to a symbol immediately after the PSFCH. For example, the RIS-dedicated control channel is mapped to a symbol two positions after the last symbol of the PSSCH.

Furthermore, for example, the number of symbols of the RIS-dedicated control channel may be fixed to one, or may be configured by the RRC signaling.

Furthermore, in the frequency direction of the RIS-dedicated control channel, the number of resource blocks of the RIS-dedicated control channel may be determined based on a predetermined parameter. Alternatively, the number of resource blocks may be configured by the RRC signaling.

For example, the predetermined parameter is the number of resource blocks of the resource pool, the number of resource blocks included in one subchannel, the number of resource blocks of the PSCCH, and the number of resource blocks of the PSSCH.

The number of resource blocks of the RIS-dedicated control channel may be predefined to be the same as the predetermined parameter.

### 5-2. Existing Dedicated Control Channel and Control Format

Here, a case where the RIS control information is notified through a conventional (existing) dedicated control channel and control format will be described. That is, the RIS control information is multiplexed with the control information addressed to the reception device 40R and notified.

In a case where the base station 20 notifies of the RIS control information, the RIS-dedicated control format may be transmitted to one predetermined RIS 30. Alternatively, the RIS-dedicated control format may be transmitted to a plurality of predetermined RISs 30 (predetermined RIS group).

The RIS-dedicated control format may be defined as a DCI format different from the conventional DCI format. The RIS-dedicated control format may be transmitted on a conventional PDCCH.

In a case where the terminal device 40 (the transmission device 40T, the reception device 40R, and/or another terminal device 40) notifies of the RIS control information, RIS-dedicated SCI thereof may be transmitted to one predetermined RIS 30. Alternatively, the RIS-dedicated SCI may be transmitted to a plurality of predetermined RISs 30 (predetermined RIS group).

### First Example of Existing Control Channel

FIG. 20 is a diagram illustrating a first example of mapping of the existing control channel according to an embodiment of the present disclosure. In this example, the sidelink control information (described as R-SCI in FIG. 20) in the RIS-dedicated control format is transmitted on the conventional PSCCH.

In this case, the RIS-dedicated SCI (R-SCI) may be transmitted on the same PSCCH as the conventional SCI (that is, the SCI format 1-A) (that is, multiplexed with the SCI format 1-A). Alternatively, the RIS-dedicated SCI may be transmitted on a PSCCH different from that of the conventional SCI.

### Second Example of Existing Control Channel

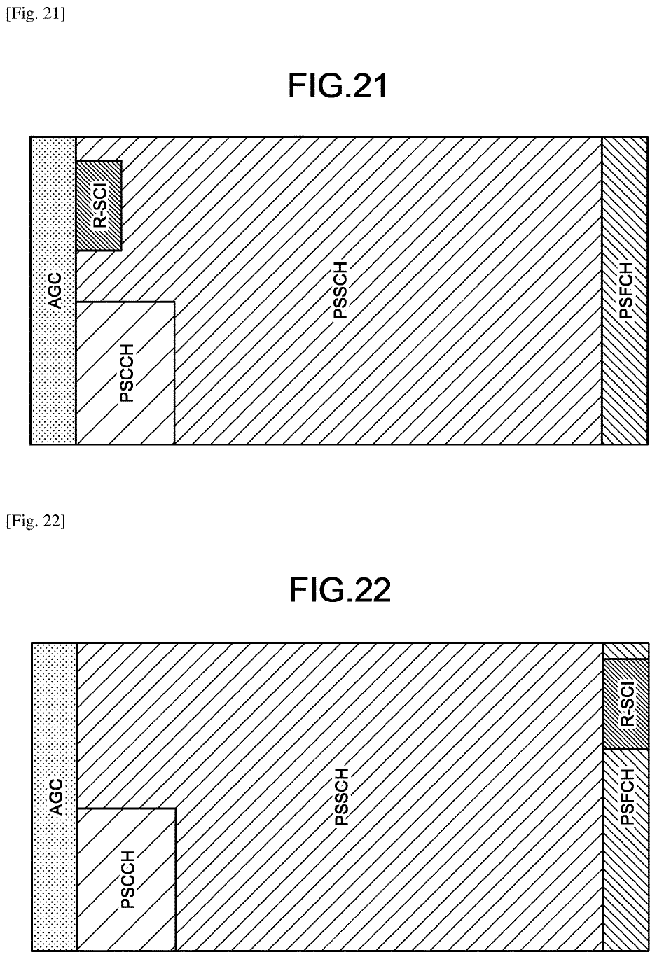

FIG. 21 is a diagram illustrating a second example of the mapping of the existing control channel according to an embodiment of the present disclosure. In this example, the sidelink control information (described as R-SCI in FIG. 21) in the RIS-dedicated control format is transmitted on the conventional PSSCH. That is, the RIS-dedicated SCI is multiplexed with the conventional second SCI and SL-SCH on the conventional PSSCH.

The mapping of the RIS-dedicated SCI on the conventional PSSCH is determined based on the mapping of the conventional second SCI. For example, the RIS-dedicated SCI is continuously mapped with the conventional second SCI.

### Third Example of Existing Control Channel

FIG. 22 is a diagram illustrating a third example of the mapping of the existing control channel according to an embodiment of the present disclosure. In this example, the sidelink control information (described as R-SCI in FIG. 22) in the RIS-dedicated control format is transmitted on the conventional PSFCH.

In this case, the RIS-dedicated SCI may be transmitted on the same PSFCH as the conventional HARQ-ACK (HARQ feedback information)(that is, multiplexed with the HARQ-ACK). Alternatively, the RIS-dedicated SCI may be transmitted on a PSFCH different from that of the conventional HARQ-ACK.

### 5-3. Control Format for Reception Device

Here, the terminal device 40 (the reception device 40R and/or another terminal device 40) multiplexes the RIS control information with a control format for the reception device 40R (conventional SCI) and makes a notification thereof.

For example, the RIS control information is multiplexed (added) with SCI for the reception device 40R through the PSCCH and/or PSSCH for the reception device 40R. At this time, the RIS control information may be transmitted as information (for example, SCI defined in another SCI format) different from the SCI for the reception device 40R. Alternatively, the RIS control information may be transmitted as control information in the SCI for the reception device 40R (that is, as the same SCI format without being distinguished from the SCI for the reception device 40R).

That is, in this example, both the reception device 40R and the RIS 30 receive the PSCCH and the SCI. However, the pieces of SCI required by the reception device 40R and the RIS 30 may be different from each other. Therefore, the reception device 40R does not have to receive the SCI required by the RIS 30 (in this case, the reception device 40R can be recognized as reservation).

### 6. Control of RIS According to Cast Type

In the present embodiment, the control of the RIS 30 may be performed according to the cast type in the sidelink communication.

For example, the method of controlling the RIS 30 according to the present embodiment can be individually set (defined) for each cast type. The RIS 30 can be controlled (or perform control) by being switched according to the cast type in predetermined sidelink communication by the RIS 30, the base station 20, or the terminal device 40.

An example of a specific control method is as follows. Note that the following control method is an example, and the RIS 30 may be controlled by a method other than the control method described below.

### RIS Control

The RIS control is determined according to the cast type (set individually). For example, the RIS control includes control related to beamforming in the sidelink communication, control related to on/off control in the sidelink communication, or power control in the sidelink communication.

In the RIS 30, the RIS control is individually configured for each cast type. For example, in the RIS 30, the control related to beamforming in the sidelink communication is individually configured for broadcast, groupcast, and/or unicast.

The configurable RIS control is defined to be different depending on the cast type. For example, in the RIS 30, the control related to beamforming in the sidelink communication can be configured for groupcast or unicast, and cannot be configured for broadcast.

The sidelink communication in which the RIS control can be performed is determined according to the cast type. That is, the RIS 30 performs the RIS control according to the cast type of the sidelink communication from the transmission device 40T.

For example, in a case where the cast type of the sidelink communication from the reception device 40R is unicast, the RIS 30 performs the RIS control (for example, beamforming) on the sidelink communication. In a case where the cast type is broadcast, the RIS 30 does not perform the RIS control on the sidelink communication.

### RIS Control Information

In predetermined RIS control, the RIS control information is determined (individually configured) according to the cast type. For example, the RIS control information varying according to the cast type includes a type, a content, the number, a bit size (payload size), and the like of information.

For example, in the control related to beamforming in the sidelink communication, the bit size of the RIS control information to be notified is determined according to the cast type. For example, in the sidelink transmission of unicast, beamforming is controlled more finely than in a case of groupcast. Therefore, the bit size of the RIS control information related to beamforming in unicast is larger than that in groupcast.

For example, in a case of unicast, the RIS control information includes at least a destination ID (information indicating the reception device 40R). In a case of groupcast, the RIS control information includes at least a target group UE ID (information indicating a group UE serving as the reception device 40R). In a case of broadcast, the RIS control information does not at least include the information indicating the reception device 40R.

### Control Channel and Control Format

The control channel and/or control format for transmitting the RIS control information are determined (individually configured) according to the cast type. For example, for unicast, the RIS control information is transmitted by using the RIS-dedicated control channel. For example, for broadcast, the RIS control information is transmitted by using the conventional PSCCH.

### 7. Estimation of Channel Information

Hitherto, channel information is estimated using a channel state information reference signal (CSI-RS) in the sidelink communication of 5G NR. In the sidelink communication of 5G NR, a channel information estimation method using the CSI-RS (SL CSI-RS) is supported only in unicast (unicast communication).

The SL CSI-RS is transmitted on the PSSCH. The transmission device 40T transmits the SL CSI-RS together with a CSI request transmitted by the SCI. The reception device 40R that has received the CSI request and the SL CSI-RS measures the CSI by using the SL CSI-RS. The reception device 40R feeds back the measured CSI to the transmission device 40T as a CSI report by using the PSSCH.

Also in the present embodiment, channel estimation of a radio link via the RIS 30 can be performed. In order to control the RIS 30 described above, it is important to estimate a channel of a communication path including the RIS 30. More specifically, it is important to estimate a channel between the transmission device 40T and the RIS 30 in which the sidelink communication SL-R1 is performed and a channel between the RIS 30 and the reception device 40R in which the sidelink communication SL-R2 is performed.

Therefore, for example, the RIS 30 (an example of a relay device) according to the present embodiment includes the antenna unit 311. The antenna unit 311 relays the sidelink communication SL-R performed between the transmission device 40T and RIS 30. The RIS 30 transmits, to the transmission device 40T and/or the reception device 40R, at least one of the first information (for example, a signal for CSI measurement and/or CSI information) regarding the quality of communication with the transmission device 40T or the second information (a signal for CSI measurement and/or CSI information) regarding the quality of communication with the reception device 40R.

Hereinafter, a specific example of a method of estimating the communication quality (channel information) of the communication path including the RIS 30 in the sidelink communication according to the present embodiment will be described.

### 7-1. Case Where RIS is Non-Transparent

A CSI acquisition method (channel estimation method) in a case where the RIS 30 is involved in signaling for CSI information acquisition, in other words, in a case where the RIS 30 is non-transparent will be described.

In this case, the RIS 30 is assumed to have a function equivalent to that of the terminal device 40 capable of transmitting and receiving a control signal for CSI measurement and a signal for feeding back the CSI information, such as the CSI-RS and a sounding reference signal (SRS). More specifically, the RIS 30 includes a measurement unit that measures the CSI (an example of a quality of communication). In the example of FIG. 9, the control unit 34 can function as a measurement unit. In addition, the RIS 30 includes a communication unit that transmits a CSI measurement result to the transmission device 40T. In the example of FIG. 9, the signal processing unit 32 can function as the communication unit. In addition, the RIS 30 includes a communication unit that transmits the signal for CSI measurement (an example of a signal for measuring the communication quality) to the transmission device 40T and/or the reception device 40R. In the example of FIG. 9, the relay unit 31 and/or the signal processing unit 32 can function as the communication unit.

### Example of First Acquisition Method

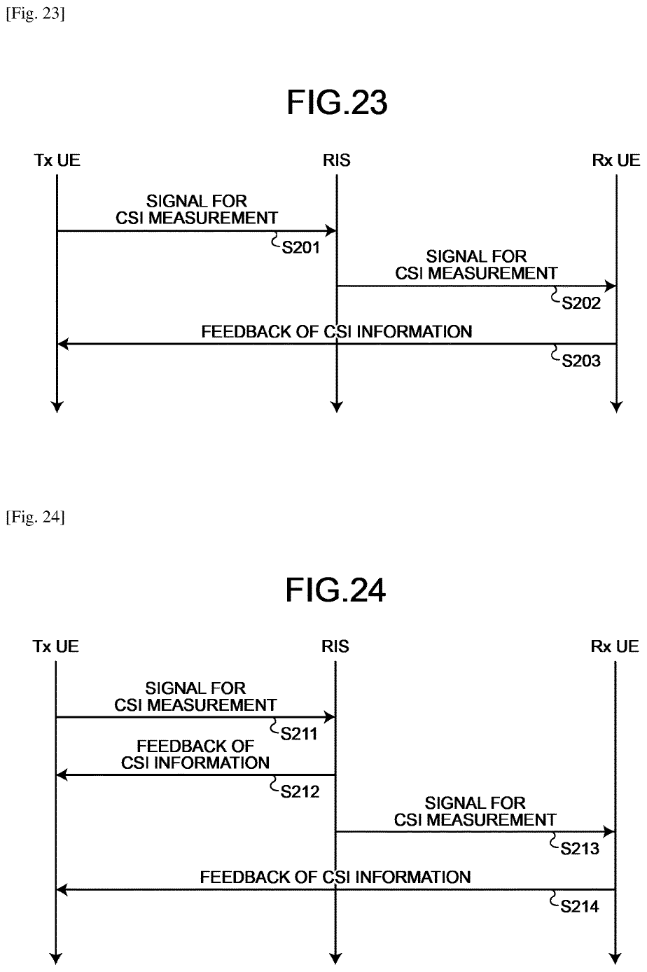

FIG. 23 is a sequence diagram illustrating an example of a flow of a first acquisition method for the CSI in a case where the RIS 30 according to an embodiment of the present disclosure is non-transparent.

The transmission device 40T transmits the signal for CSI measurement to the RIS 30 (step S201). The signal for CSI measurement may be the sidelink signal (the SL CSI-RS in the PSSCH) or a signal equivalent to the CSI-RS or the SRS. Alternatively, the signal for CSI measurement may be a newly defined signal.

Upon receiving the signal for CSI measurement, the RIS 30 transmits the signal for CSI measurement to the reception device 40R (step S202).

The signal for CSI measurement transmitted by the RIS 30 may be the sidelink signal (the SL CSI-RS in the PSSCH) or a signal equivalent to the CSI-RS or the SRS. Alternatively, the signal for CSI measurement may be a newly defined signal.

In addition, the signal for CSI measurement transmitted by the RIS 30 may be the same as or different from the signal for CSI measurement transmitted by the transmission device 40T.

In addition, the channel information (for example, the signal for feeding back the CSI information) measured by the RIS 30 may be included in the signal for CSI measurement transmitted by the RIS 30.

The reception device 40R aggregates the CSI information related to the channel between the transmission device 40T and the RIS 30 and the CSI information related to the channel between the RIS 30 and the reception device 40R acquired by a series of operations, and feeds back the aggregated information to the transmission device 40T (step S203).

The reception device 40R may feed back the CSI information to the transmission device 40T via the RIS 30, or may feed back the CSI information directly to the transmission device 40T without via the RIS 30.

As described above, in the example of the first acquisition method, the transmission device 40T and the RIS 30 transmit a signal for channel measurement (for example, the signal for CSI measurement). In addition, the RIS 30 and the reception device 40R measure a channel state (communication quality) by using the signal for channel measurement. In addition, the RIS 30 notifies the reception device 40R of the measurement result. The reception device 40R aggregates its own measurement result and the measurement result of the RIS 30 and feeds back the aggregated result to the transmission device 40T.

### Example of Second Acquisition Method

FIG. 24 is a sequence diagram illustrating an example of a flow of a second acquisition method for the CSI in a case where the RIS 30 according to an embodiment of the present disclosure is non-transparent.

The transmission device 40T transmits the signal for CSI measurement to the RIS 30 (step S211). The signal for CSI measurement may be the sidelink signal (the SL CSI-RS in the PSSCH) or a signal equivalent to the CSI-RS or the SRS. Alternatively, the signal for CSI measurement may be a newly defined signal.

Upon receiving the signal for CSI measurement, the RIS 30 feeds back the CSI information related to the channel between the transmission device 40T and the RIS 30 to the transmission device 40T (step S212).

The RIS 30 transmits the signal for CSI measurement to the reception device 40R (step S213). The signal for CSI measurement transmitted by the RIS 30 may be the sidelink signal (the SL CSI-RS in the PSSCH) or a signal equivalent to the CSI-RS or the SRS. Alternatively, the signal for CSI measurement may be a newly defined signal.

In addition, the signal for CSI measurement transmitted by the RIS 30 may be the same as or different from the signal for CSI measurement transmitted by the transmission device 40T.

Upon receiving the signal for CSI measurement, the reception device 40R feeds back the CSI information related to the channel between the RIS 30 and the reception device 40R to the transmission device 40T (step S214).

The reception device 40R may feed back the CSI information to the transmission device 40T via the RIS 30, or may feed back the CSI information directly to the transmission device 40T without via the RIS 30.

As described above, in the example of the second acquisition method, the transmission device 40T and the RIS 30 transmit a signal for channel measurement (for example, the signal for CSI measurement). In addition, the RIS 30 and the reception device 40R measure a channel state (communication quality) by using the signal for channel measurement. In addition, the RIS 30 feeds back the measurement result to the transmission device 40T. The reception device 40R feeds back the measurement result to the transmission device 40T.

### Example of Third Acquisition Method

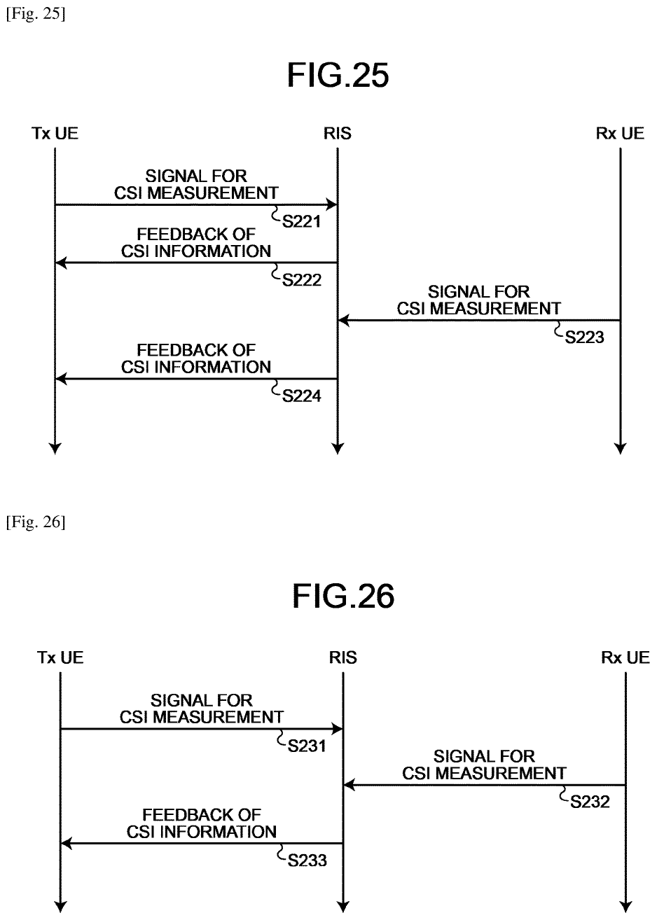

FIG. 25 is a sequence diagram illustrating an example of a flow of a third acquisition method for the CSI in a case where the RIS 30 according to an embodiment of the present disclosure is non-transparent.

The transmission device 40T transmits the signal for CSI measurement to the RIS 30 (step S221). The signal for CSI measurement may be the sidelink signal (the SL CSI-RS in the PSSCH) or a signal equivalent to the CSI-RS or the SRS. Alternatively, the signal for CSI measurement may be a newly defined signal.

Upon receiving the signal for CSI measurement, the RIS 30 feeds back the CSI information related to the channel between the transmission device 40T and the RIS 30 to the transmission device 40T (step S222).

The reception device 40R transmits the signal for CSI measurement to the RIS 30 (step S223). The signal for CSI measurement transmitted by the reception device 40R may be the sidelink signal (the SL CSI-RS in the PSSCH) or a signal equivalent to the CSI-RS or the SRS. Alternatively, the signal for CSI measurement may be a newly defined signal.

In addition, the signal for CSI measurement transmitted by the reception device 40R may be the same as or different from the signal for CSI measurement transmitted by the transmission device 40T.

Upon receiving the signal for CSI measurement, the RIS 30 feeds back the CSI information related to the channel between the RIS 30 and the reception device 40R to the transmission device 40T (step S224).

As described above, in the example of the third acquisition method, the transmission device 40T and the reception device 40R transmit a signal for channel measurement (for example, the signal for CSI measurement). In addition, the RIS 30 measures the channel state (communication quality) by using the signal for channel measurement. In addition, the RIS 30 feeds back the measurement result to the transmission device 40T.

### Example of Fourth Acquisition Method

FIG. 26 is a sequence diagram illustrating an example of a flow of a fourth acquisition method for the CSI in a case where the RIS 30 according to an embodiment of the present disclosure is non-transparent.

The transmission device 40T transmits the signal for CSI measurement to the RIS 30 (step S231). The signal for CSI measurement may be the sidelink signal (the SL CSI-RS in the PSSCH) or a signal equivalent to the CSI-RS or the SRS. Alternatively, the signal for CSI measurement may be a newly defined signal.

The reception device 40R transmits the signal for CSI measurement to the RIS 30 (step S232). The signal for CSI measurement transmitted by the reception device 40R may be the sidelink signal (the SL CSI-RS in the PSSCH) or a signal equivalent to the CSI-RS or the SRS. Alternatively, the signal for CSI measurement may be a newly defined signal.

In addition, the signal for CSI measurement transmitted by the reception device 40R may be the same as or different from the signal for CSI measurement transmitted by the transmission device 40T.

The RIS 30 aggregates the CSI information related to the channel between the transmission device 40T and the RIS 30 and the CSI information related to the channel between the RIS 30 and the reception device 40R, and feeds back the aggregated information to the transmission device 40T (step S243).

As described above, in the example of the fourth acquisition method, the transmission device 40T and the reception device 40R transmit a signal for channel measurement (for example, the signal for CSI measurement). In addition, the RIS 30 measures the channel state (communication quality) by using the signal for channel measurement. In addition, the RIS 30 aggregates and feeds back the measurement results to the transmission device 40T.

### Example of Fifth Acquisition Method

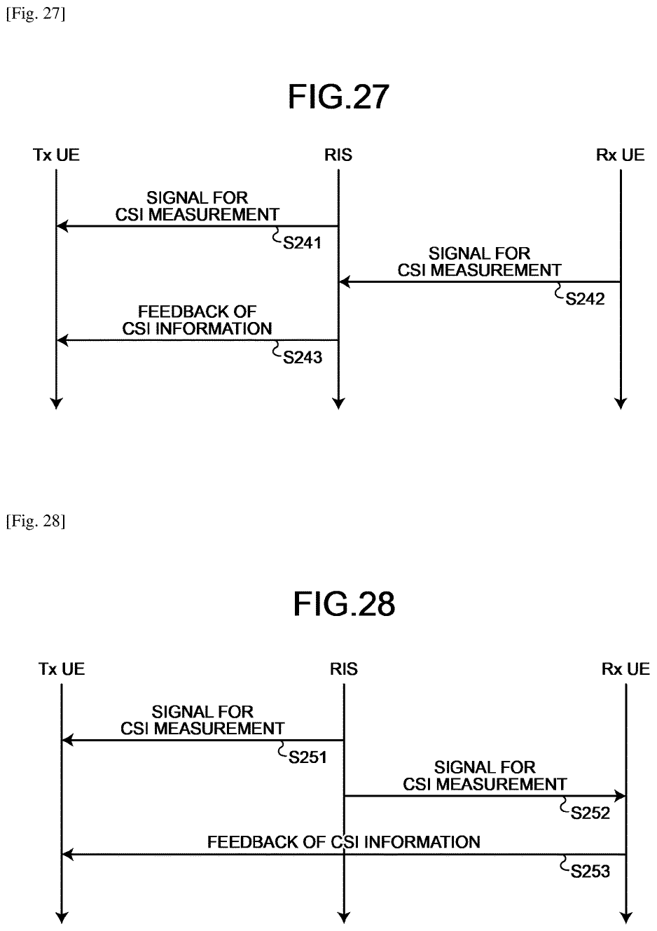

FIG. 27 is a sequence diagram illustrating an example of a flow of a fifth acquisition method for the CSI in a case where the RIS 30 according to an embodiment of the present disclosure is non-transparent.

The RIS 30 transmits the signal for CSI measurement to the transmission device 40T (step S241). The signal for CSI measurement may be the sidelink signal (the SL CSI-RS in the PSSCH) or a signal equivalent to the CSI-RS or the SRS. Alternatively, the signal for CSI measurement may be a newly defined signal.

The reception device 40R transmits the signal for CSI measurement to the RIS 30 (step S242). The signal for CSI measurement transmitted by the reception device 40R may be the sidelink signal (the SL CSI-RS in the PSSCH) or a signal equivalent to the CSI-RS or the SRS. Alternatively, the signal for CSI measurement may be a newly defined signal.

In addition, the signal for CSI measurement transmitted by the reception device 40R may be the same as or different from the signal for CSI measurement transmitted by the RIS 30.

The RIS 30 feeds back the CSI information related to the channel between the RIS 30 and the reception device 40R to the transmission device 40T (step S233).

As described above, in the example of the fifth acquisition method, the RIS 30 and the reception device 40R transmit a signal for channel measurement (for example, the signal for CSI measurement). In addition, the transmission device 40T and the RIS 30 measure the channel state (communication quality) by using the signal for channel measurement. In addition, the RIS 30 feeds back the measurement result to the transmission device 40T.

### Example of Sixth Acquisition Method

FIG. 28 is a sequence diagram illustrating an example of a flow of a sixth acquisition method for the CSI in a case where the RIS 30 according to an embodiment of the present disclosure is non-transparent.

The RIS 30 transmits the signal for CSI measurement to the transmission device 40T (step S251). The signal for CSI measurement may be the sidelink signal (the SL CSI-RS in the PSSCH) or a signal equivalent to the CSI-RS or the SRS. Alternatively, the signal for CSI measurement may be a newly defined signal.

The RIS 30 transmits the signal for CSI measurement to the reception device 40R (step S252). The signal for CSI measurement may be the sidelink signal (the SL CSI-RS in the PSSCH) or a signal equivalent to the CSI-RS or the SRS. Alternatively, the signal for CSI measurement may be a newly defined signal.

In addition, the signal for CSI measurement transmitted by the RIS 30 to the reception device 40R may be the same as or different from the signal for CSI measurement transmitted by the RIS 30 to the transmission device 40T.

The reception device 40R feeds back the CSI information related to the channel between the RIS 30 and the reception device 40R to the transmission device 40T (step S253).

The reception device 40R may feed back the CSI information to the transmission device 40T via the RIS 30, or may feed back the CSI information directly to the transmission device 40T without via the RIS 30.

As described above, in the example of the sixth acquisition method, the RIS 30 transmits a signal for channel measurement (for example, the signal for CSI measurement). In addition, the transmission device 40T and the reception device 40R measure the channel state (communication quality) by using the signal for channel measurement. Further, the reception device 40R feeds back the measurement result to the transmission device 40T.

### Example of Seventh Acquisition Method

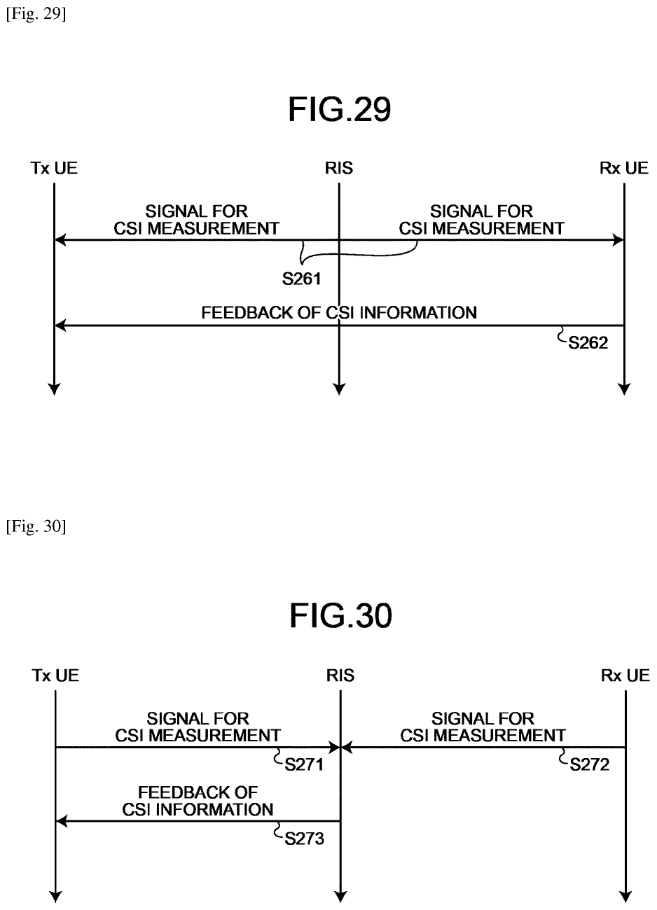

FIG. 29 is a sequence diagram illustrating an example of a flow of a seventh acquisition method for the CSI in a case where the RIS 30 according to an embodiment of the present disclosure is non-transparent.

The RIS 30 transmits the signal for CSI measurement to the transmission device 40T and the reception device 40R (step S261). The signal for CSI measurement may be the sidelink signal (the SL CSI-RS in the PSSCH) or a signal equivalent to the CSI-RS or the SRS. Alternatively, the signal for CSI measurement may be a newly defined signal.

As described above, in this example, the RIS 30 simultaneously transmits the same signal for CSI measurement to the transmission device 40T and the reception device 40R.

The reception device 40R feeds back the CSI information related to the channel between the RIS 30 and the reception device 40R to the transmission device 40T (step S262).

The reception device 40R may feed back the CSI information to the transmission device 40T via the RIS 30, or may feed back the CSI information directly to the transmission device 40T without via the RIS 30.

As described above, in the example of the seventh acquisition method, the RIS 30 transmits a signal for channel measurement (for example, the signal for CSI measurement). In addition, the transmission device 40T and the reception device 40R measure the channel state (communication quality) by using the signal for channel measurement. Further, the reception device 40R feeds back the measurement result to the transmission device 40T.

### Example of Eighth Acquisition Method

FIG. 30 is a sequence diagram illustrating an example of a flow of an eighth acquisition method for the CSI in a case where the RIS 30 according to an embodiment of the present disclosure is non-transparent.

The transmission device 40T transmits the signal for CSI measurement to the RIS 30 (step S271), and the reception device 40R transmits the signal for CSI measurement to the RIS 30 (step S272).

The signal for CSI measurement may be the sidelink signal (the SL CSI-RS in the PSSCH) or a signal equivalent to the CSI-RS or the SRS. Alternatively, the signal for CSI measurement may be a newly defined signal.

As described above, in this example, the transmission device 40T and the reception device 40R transmit the same signal for CSI measurement to the RIS 30. Note that the signals for CSI measurement transmitted by the transmission device 40T and the reception device 40R can be multiplexed, for example, in the frequency direction (or time direction).

The RIS 30 feeds back the CSI information related to the channel between the RIS 30 and the reception device 40R to the transmission device 40T (step S273).

As described above, in the example of the eighth acquisition method, the transmission device 40T and the reception device 40R transmit a signal for channel measurement (for example, the signal for CSI measurement). In addition, the RIS 30 measures the channel state (communication quality) by using the signal for channel measurement. In addition, the RIS 30 feeds back the measurement result to the transmission device 40T.

### 7-2. Case Where RIS is Transparent

A CSI acquisition method (channel estimation method) in a case where the RIS 30 is not involved in signaling for CSI information acquisition, in other words, in a case where the RIS 30 is transparent will be described.

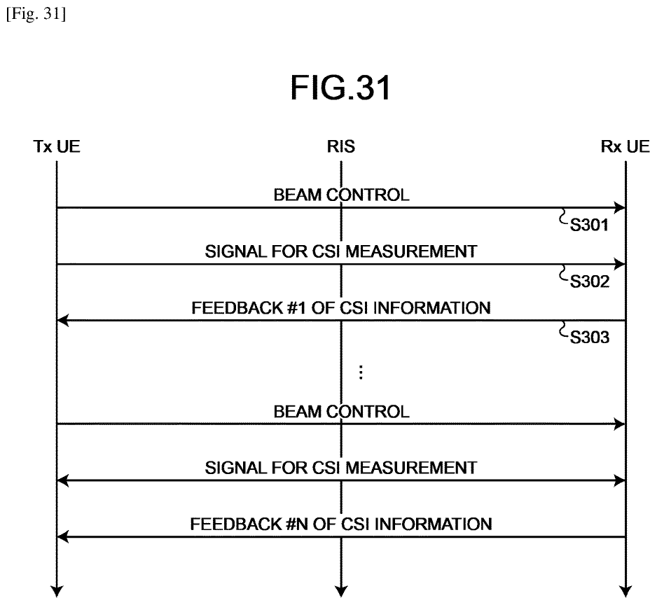

FIG. 31 is a sequence diagram illustrating an example of a flow of the acquisition method for the CSI in a case where the RIS 30 according to an embodiment of the present disclosure is transparent.

In this case, the transmission device 40T transmits, for example, the above-described RIS control information to the RIS 30 via the control link, and performs the beam control of the RIS 30 (step S301).

At this time, a beam pattern controlled by the transmission device 40T may be selected from among predefined patterns, or may be determined from position information of the terminal device 40 (the transmission device 40T and the reception device 40R) or the like.

Thereafter, the transmission device 40T transmits the signal for CSI measurement to the reception device 40R (step S302). At this time, the transmission device 40T transmits the signal for CSI measurement to the reception device 40R via the RIS 30.

Upon receiving the signal for CSI measurement, the reception device 40R feeds back the CSI information to the transmission device 40T (step S303). As described below, the reception device 40R feeds back the CSI information a plurality of times, for example. In the example of FIG. 31, the feedback of the CSI information performed by the reception device 40R in step S303 is the first feedback (feedback #1).

The reception device 40R may feed back the CSI information to the transmission device 40T via the RIS 30, or may feed back the CSI information directly to the transmission device 40T without via the RIS 30.

In this example, the channel between the transmission device 40T and the RIS 30 and the channel between the RIS 30 and the reception device 40R are measured as a single channel.

The transmission device 40T changes the beam pattern and transmits the signal for CSI measurement to the reception device 40R. In this manner, the communication system S repeats the above CSI measurement (steps S301 to S303) with different beam patterns (for example, first to N-th beam patterns). For example, in FIG. 31, the communication system S repeats the CSI measurement N times (N is a natural number of 1 or more).

Note that, in these operations, the RIS 30 does not signal a signal related to a CSI operation.

### 8. RIS Selection

### 8-1. RIS Selection Operation

In a case where there are a plurality of RISs 30 around the transmission device 40T and the reception device 40R, the transmission device 40T is required to select the RIS 30 to be used for the sidelink communication.

In particular, the sidelink communication is performed between the terminal devices 40. Since the terminal device 40 is movable, when the transmission device 40T and the reception device 40R perform the sidelink communication, there may be an RIS 30 that is not arranged in a position and/or orientation suitable for improving a propagation channel among the plurality of RISs 30.

In a case where the RIS 30 whose position and/or orientation are not suitable for improving the propagation channel is used for relaying the sidelink communication, a communication quality improvement effect assumed in the sidelink communication between the transmission device 40T and the reception device 40R may not be obtained.

Therefore, in the present embodiment, the transmission device 40T and the reception device 40R determine whether or not to perform the sidelink communication using the RIS 30 and select an appropriate RIS 30. The selection of the RIS 30 is performed by the communication system S before the CSI acquisition method described above.

Note that the acquisition of the CSI may be performed immediately after the selection of the RIS 30, or may be performed by being triggered by at least one of the base station 20, the terminal device 40 (the transmission device 40T, the reception device 40R, and/or another terminal device 40), or the RIS 30 after the selection of the RIS 30.

Furthermore, the transmission device 40T can select the RIS 30 periodically or at the time of execution of a predetermined event such as transition of an operation mode. Alternatively, the transmission device 40T may select the RIS 30 according to an instruction from the base station 20. That is, the operation of selecting the RIS 30 according to the present embodiment may be triggered by the base station 20. In this case, the base station 20 transmits, for example, a trigger signal for triggering the operation of selecting the RIS 30 to the transmission device 40T.

The communication system S according to the present embodiment performs the operation of selecting the RIS 30, so that the transmission device 40T can select the RIS 30 suitable for performing the sidelink communication.

In addition, the communication system S acquires the CSI of the radio link including the selected RIS 30 after the operation of selecting the RIS 30. As a result, the communication system S can avoid acquiring the CSI for the unnecessary RIS 30. The communication system S can reduce signaling overheads due to the CSI acquisition by avoiding unnecessary CSI acquisition.

Although it has been described here that the transmission device 40T selects the RIS 30, at least one of the reception device 40R, another terminal device 40, or the base station 20 may select the RIS 30.

Hereinafter, a specific example of the operation of selecting the RIS 30 for each subject selecting the RIS 30 will be described. In the following RIS selection operation, the RIS 30 to be used for the sidelink communication is selected from among an RIS 30_1 (RIS #1), an RIS 30_K (RIS #K), and an RIS 30_N (RIS #N).

In addition, the number of RISs 30 to be selected may be two or more, and may be four or more. The RIS 30 to be selected has a function of signaling information for determining whether or not to perform the sidelink communication using the RIS 30 and information for selecting an appropriate RIS 30.

### Case where Transmission Device 40T Performs Selection

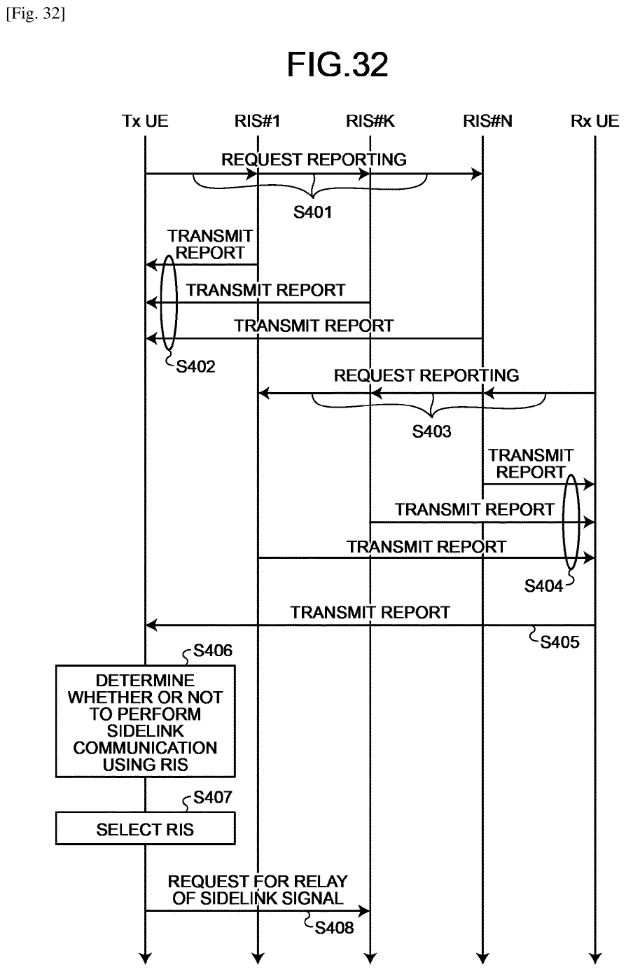

FIG. 32 is a sequence diagram illustrating an example of a flow of the RIS selection operation of selecting the RIS 30 by the transmission device 40T according to an embodiment of the present disclosure.

The transmission device 40T transmits a signal (an example of a signal requesting reporting and a selection signal) for selecting the RIS 30 to surrounding RISs 30 (here, RISs 30_1, 30_K, and 30_N) (step S401). The signal for selecting the RIS 30 stores information requesting reporting of information for selecting the RIS 30.

Upon receiving the signal for selecting the RIS 30, the RISs 30_1, 30_K, and 30_N transmit a signal for feeding back the information for selecting the RIS 30 (an example of a report and a feedback signal) to the transmission device 40T that is a transmission source (step S402).

The reception device 40R transmits the signal for selecting the RIS 30 (a signal for requesting reporting) to the surrounding RISs 30 (here, RISs 30_1, 30_K, and 30_N) (step S403). The signal for selecting the RIS 30 stores information requesting reporting of information for selecting the RIS 30.

Upon receiving the signal for selecting the RIS 30, the RISs 30_1, 30_K, and 30_N transmit a signal for feeding back the information (report) for selecting the RIS 30 to the reception device 40R that is a transmission source (step S404).

The reception device 40R transmits a signal for reporting the information for selecting the RIS 30 to the transmission device 40T (step S405). The report may include information regarding the report received in step S404.

The transmission device 40T determines whether or not to perform the sidelink communication using the RIS 30 based on the reports acquired from the surrounding RISs 30 and the report acquired from the reception device 40R (step S406).

In a case where it is determined to perform the sidelink communication using the RIS 30, the transmission device 40T selects the RIS 30 to be used for the sidelink communication (step S407). Here, it is assumed that the transmission device 40T selects the RIS 30_K (RIS #K).

The transmission device 40T requests the selected RIS 30_K to relay the sidelink signal (step S408).

The transmission device 40T may notify the reception device 40R of the selection result. Furthermore, here, the transmission device 40T requests the RIS 30_K to relay the sidelink signal, but the reception device 40R may request the RIS 30_K instead of the transmission device 40T.

### Case where Reception Device 40R Performs Selection

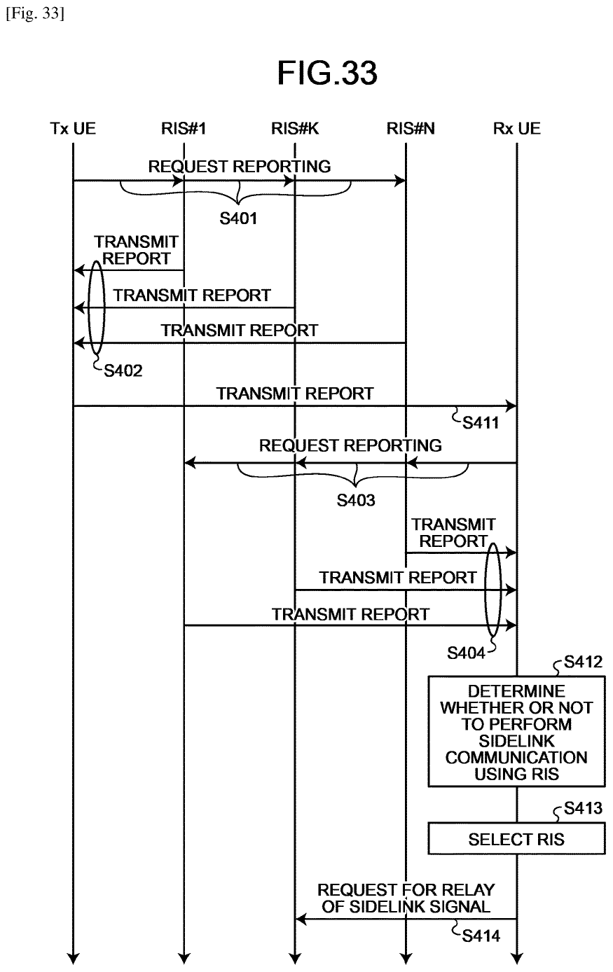

FIG. 33 is a sequence diagram illustrating an example of a flow of the RIS selection operation of selecting the RIS 30 by the reception device 40R according to an embodiment of the present disclosure. The same processing as that in FIG. 32 is denoted by the same reference numerals, and a description thereof is omitted.

Upon receiving the reports from the RISs 30_1, 30_K, and 30_N in step S402, the transmission device 40T transmits the signal for reporting the information for selecting the RIS 30 to the reception device 40R (step S411). The report may include information regarding the report received in step S402.

The reception device 40R determines whether or not to perform the sidelink communication using the RIS 30 based on the reports acquired from the surrounding RISs 30 and the report acquired from the transmission device 40T (step S412).

In a case where it is determined to perform the sidelink communication using the RIS 30, the reception device 40R selects the RIS 30 to be used for the sidelink communication (step S413). Here, it is assumed that the reception device 40R selects the RIS 30_K (RIS #K).

The reception device 40R requests the selected RIS 30_K to relay the sidelink signal (step S414).

The reception device 40R may notify the transmission device 40T of the selection result. Furthermore, here, the reception device 40R requests the RIS 30_K to relay the sidelink signal, but the transmission device 40T may request the RIS 30_K instead of the reception device 40R.

### Case where Base Station 20 Performs Selection

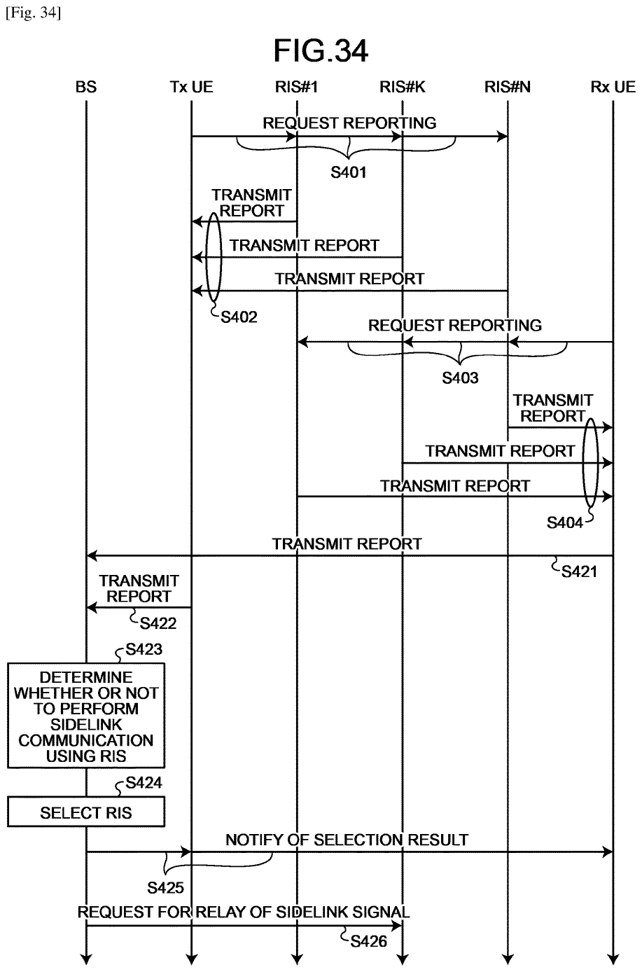

FIG. 34 is a sequence diagram illustrating an example of a flow of the RIS selection operation of selecting the RIS 30 by the base station 20 according to an embodiment of the present disclosure. The same processing as that in FIG. 32 is denoted by the same reference numerals, and a description thereof is omitted.

Upon receiving the reports from the RISs 30_1, 30_K, and 30_N in step S404, the reception device 40R transmits the signal for reporting the information for selecting the RIS 30 to the base station 20 (step S421). The report may include information regarding the report received in step S404.

The transmission device 40T transmits the signal for reporting the information for selecting the RIS 30 to the base station 20 (step S422). The report may include information regarding the report received in step S402.

The base station 20 determines whether or not to perform the sidelink communication using the RIS 30 based on the reports acquired from the transmission device 40T and the reception device 40R (step S423).

In a case where it is determined to perform the sidelink communication using the RIS 30, the base station 20 selects the RIS 30 to be used for the sidelink communication (step S424). Here, it is assumed that reception device 40R selects the RIS 30_K (RIS #K).

The base station 20 notifies the transmission device 40T and the reception device 40R of the result of selecting the RIS 30 (step S425). Here, the base station 20 notifies both the transmission device 40T and the reception device 40R of the selection result, but the base station 20 may notify one of the transmission device 40T and the reception device 40R of the selection result.

The base station 20 requests the selected RIS 30_K to relay the sidelink signal (step S426). Here, the base station 20 requests the RIS 30_K to relay the sidelink signal, but the transmission device 40T and/or the reception device 40R may request the RIS 30_K instead of the base station 20.

Furthermore, here, each of the transmission device 40T and the reception device 40R transmits the report to the base station 20, but one of the transmission device 40T and the reception device 40R may transmit the report to the base station 20.

For example, in a case where the transmission device 40T transmits the report to the base station 20, the reception device 40R transmits the signal for reporting the information for selecting the RIS 30 to the transmission device 40T based on the reports acquired from the surrounding RISs 30. The transmission device 40T transmits a report including the information regarding the report received from the reception device 40R to the base station 20.

Furthermore, a timing at which each of the transmission device 40T and the reception device 40R transmits the report to the base station 20 is not limited to the example of FIG. 34. The transmission device 40T and the reception device 40R may transmit the report before the base station 20 selects the RIS 30. For example, the transmission device 40T may transmit the report to the base station 20 immediately after receiving the reports from the surrounding RISs 30 in step S402.

Although the base station 20 selects the RIS 30 here, another terminal device 40 may select the RIS 30 instead of the base station 20.

In a case where the plurality of RISs 30 to be selected include a transparent RIS 30, the base station 20 may transmit the information (report) for selecting the RIS 30 to the transmission device 40T and/or the reception device 40R instead of the transparent RIS 30. Further, the transmission device 40T and/or the reception device 40R may transmit a report request to the base station 20 instead of the transparent RIS 30.

### 8-2. Example of Signal in RIS Selection

Here, for example, at least one of the following pieces of information can be included as the information for selecting the RIS 30.
Identification information of RIS 30
Information regarding reception state of RIS 30
Information regarding relay capability of RIS 30

### Identification Information of RIS 30

The identification information of the RIS 30 includes ID information of the RIS 30. The ID information of the RIS 30 is information for distinguishing the RIS 30. Examples of the ID information of the RIS 30 include ID information allocated by the base station 20, a manufacturing number of the RIS 30, and a number defined by a manufacturer of the RIS 30.

### Information Regarding Reception State of RIS 30

The information regarding the reception state of the RIS 30 may include, for example, at least one of the following pieces of information.
Information regarding received power
Information regarding channel of RIS 30
Information regarding orientation of RIS 30
Position information of RIS 30
Information regarding execution area of RIS 30 with respect to terminal device 40
Information regarding distance between terminal device 40 and RIS 30

The information regarding the received power includes RSSI information related to the signal for selecting the RIS 30 and RSSI information related to the control signal of another terminal device 40.

The information regarding the channel of the RIS 30 includes, for example, information regarding the quality of communication between the RIS 30 and the terminal device 40 (for example, the CSI information). The information regarding the channel of the RIS 30 can include a result of CSI measurement performed between the RIS 30 and the terminal device 40 in the past. Alternatively, in a case where the past channel information (CSI measurement result) does not exist, the information regarding the channel of the RIS 30 may include information indicating that the past channel information is not held instead of the past channel information.

The information regarding the orientation of the RIS 30 may include a physical direction of the RIS 30, angle of arrival (AOA) information for a signal of the terminal device 40, and information indicating a direction of a sector to which the RIS 30 (terminal device 40) belongs in a case where the periphery of the RIS 30 is divided into sections.

The position information of the RIS 30 includes, for example, global positioning system (GPS) information regarding the position of the RIS 30 and information indicating a distance and a direction with respect to the terminal device 40.

The information regarding the execution area of the RIS 30 with respect to the terminal device 40 includes, for example, information regarding an area (for example, an area of the antenna unit 311) calculated by the size and orientation of the RIS 30 with respect to the terminal device 40.

The information regarding the distance between the terminal device 40 and the RIS 30 includes, for example, information regarding a physical distance between the terminal device 40 and the RIS 30.

### Information Regarding Relay Capability of RIS 30

The information regarding the relay capability of the RIS 30 may include, for example, at least one of the following pieces of information.
Information regarding beam formable for terminal device 40
Information regarding current operation of RIS 30
Capability information of RIS 30

The information regarding the beam formable for the terminal device 40 includes, for example, information regarding the type of the beam formable for the terminal device 40 by the RIS 30 and an assumed reflection gain.

The information regarding the current operation of the RIS 30 includes, for example, information regarding the current operation mode of the RIS 30. The capability information of the RIS 30 includes, for example, information indicating controllable phase resolution of the RIS 30 and whether or not power amplification is possible.

A signal for requesting the RIS 30 to relay the sidelink signal is, for example, a signal including information requesting a sidelink communication operation using the RIS 30 including the transmission device 40T. In addition, a signal for notifying of the selected RIS 30 includes, for example, the ID information of the RIS 30 to be used for the sidelink communication by the transmission device 40T and the reception device 40R.

### 9. Other Embodiments

The above-described embodiments show only examples, and various modifications and applications are possible.

For example, a control device that controls the base station 20, the RIS 30, and the terminal device 40 of the present embodiment may be implemented by a dedicated computer system or may be implemented by a general-purpose computer system.

For example, a communication program for performing the above-described operations is stored in a computer-readable recording medium such as an optical disk, a semiconductor memory, a magnetic tape, or a flexible disk, and distributed. Then, for example, the control device is implemented by installing the program in a computer and performing the above-described processing. At this time, the control device may be a device (for example, a personal computer) outside the base station 20, the RIS 30, or the terminal device 40. Furthermore, the control device may be a device (for example, the control unit 23, the control unit 34, or the control unit 43) inside the base station 20, the RIS 30, or the terminal device 40.

Further, the communication program may be stored in a disk device included in a server device on a network such as the Internet, and be downloaded to a computer. Further, the functions described above may be implemented by cooperation between an operating system (OS) and application software. In this case, the part other than the OS may be stored in a medium and distributed, or the part other than the OS may be stored in a server device and downloaded to a computer.

Further, among the processing described in the above-described embodiment, all or some of the processing described as being automatically performed can be manually performed. Alternatively, all or some of the processing described as being manually performed can be automatically performed by a known method. In addition, the processing procedures, specific names, information including various data and parameters illustrated in the specification and drawings can be arbitrarily changed unless otherwise specified. For example, various pieces of information illustrated in the drawings are not limited to those illustrated in the drawings.

Further, each illustrated component of each device is functionally conceptual, and does not necessarily have to be configured physically as illustrated in the drawings. That is, the specific modes of distribution/integration of the respective devices are not limited to those illustrated in the drawings. All or some of the devices can be functionally or physically distributed/integrated in any arbitrary unit, depending on various loads or the status of use. Note that this configuration by distribution and integration may be dynamically made.

Further, the above-described embodiments can be appropriately combined as long as the processing contents do not contradict each other. Further, the order of the steps illustrated in the sequence diagram or the like of the above-described embodiments can be changed as appropriate.

Furthermore, for example, the present embodiment can be implemented as any component included in the device or system, for example, a processor as a system large scale integration (LSI) or the like, a module using a plurality of processors or the like, a unit using a plurality of modules or the like, a set obtained by further adding other functions to a unit, or the like (that is, some components of the device).

Note that, in the present embodiment, the system means a set of a plurality of components (devices, modules (parts), and the like), and it does not matter whether or not all the components are in the same housing. Therefore, a plurality of devices housed in separate housings and connected via a network and one device in which a plurality of modules are housed in one housing are both systems.

Furthermore, for example, the present embodiment can adopt a configuration of cloud computing in which one function is shared and processed by a plurality of devices in cooperation via a network.

### 10. Conclusion

Although the respective embodiments of the present disclosure have been described above, the technical scope of the present disclosure is not limited to the above-described embodiments, and various modifications can be made without departing from the scope of the present disclosure. Moreover, components of different embodiments and modified examples may be appropriately combined.

Further, the effects in each embodiment described in the present specification are merely examples. The effects of the present disclosure are not limited thereto, and other effects may be obtained.

The functionality of the elements disclosed herein may be implemented using circuitry or processing circuitry which includes general purpose processors, special purpose processors, integrated circuits, ASICs (“Application Specific Integrated Circuits”), FPGAs (“Field-Programmable Gate Arrays”), conventional circuitry and/or combinations thereof which are programmed, using one or more programs stored in one or more memories, or otherwise configured to perform the disclosed functionality. Processors and controllers are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality. Also, the memory (e.g., memory 22, 33, 42) can store a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of a FPGA or ASIC.

Note that the present technology can also have the following configurations.

### 1

A relay device comprising:
a relay unit that transmits a sidelink signal transmitted through a first link from a transmission device to a reception device through a second link according to control information,
wherein the control information is notified by at least one of a base station, the transmission device, the reception device, or a communication device.

### 2

The relay device according to (1), wherein the control information includes beam information regarding beamforming in sidelink communication.

### 3

The relay device according to (1) or (2), wherein the control information includes instruction information instructing whether or not to relay sidelink communication.

### 4

The relay device according to any one of (1) to (3), wherein the control information includes power control information regarding transmitted power in a case where the sidelink signal is transmitted to the reception device.

### 5

The relay device according to any one of (1) to (4), wherein at least one of the transmission device, the reception device, or the communication device transmits the control information in a sidelink resource.

### 6

The relay device according to any one of (1) to (5), wherein the control information is notified by using a control channel different from a physical sidelink control channel (PSCCH) or a physical sidelink shared channel (PSSCH) addressed to the reception device.

### 7

The relay device according to any one of (1) to (5), wherein the control information is multiplexed with control information addressed to the reception device and notified using a PSCCH or a PSSCH addressed to the reception device, and is notified.

### 8

The relay device according to any one of (1) to (4), wherein the base station transmits the control information in a downlink resource.

### 9

The relay device according to any one of (1) to (8), wherein the control information is notified by using downlink control information (DCI) addressed to the relay device.

### 10

The relay device according to (9), wherein the control information notified by using the DCI includes information regarding sidelink between the transmission device and the reception device.

### 11

The relay device according to any one of (1) to (10), wherein a format of the control information is different from a format of control information addressed to the reception device.

### 12

The relay device according to any one of (1) to (11), wherein the control information varies depending on a cast type of sidelink communication.

### 13

A communication device comprising:
a communication unit that transmits control information to a relay device that transmits a sidelink signal transmitted by a transmission device through a first link to a reception device through a second link,
wherein the control information is used by the relay device to transmit the sidelink signal to the reception device.

### (14

A communication method comprising:
transmitting a sidelink signal transmitted through a first link from a transmission device to a reception device through a second link according to control information,
wherein the control information is notified by at least one of a base station, the transmission device, the reception device, or a communication device.

### 15

A communication method comprising:
transmitting control information to a relay device that transmits a sidelink signal transmitted by a transmission device through a first link to a reception device through a second link,
wherein the control information is used by the relay device to transmit the sidelink signal to the reception device.

### 16

A relay device comprising:
circuitry configured to transmit a sidelink signal, which is received through a first link from a transmitter, to a receiver through a second link based on control information,
wherein the control information is received by the circuitry from at least one of a base station, the transmitter, the receiver, or communication circuitry different from the base station, the transmitter, and the receiver.

### 17

The relay device according to (16), wherein the control information includes beam information regarding beamforming in sidelink communication.

### 18

The relay device according to (16) or (17), wherein the control information includes instruction information instructing whether or not to relay sidelink communication.

### 19

The relay device according to any one of (16) to (18), wherein the control information includes power control information regarding transmitted power in a case where the sidelink signal is transmitted to the receiver.

### 20

The relay device according to any one of (16) to (19), wherein the relay circuitry is configured to receive the control information in a sidelink resource from at least one of the transmitter, the receiver, or the communication circuitry.

### 21

The relay device according to any one of (16) to (20), wherein the relay circuitry is configured to receive the control information via a control channel different from a physical sidelink control channel (PSCCH) or a physical sidelink shared channel (PSSCH) addressed to the receiver.

### 22

The relay device according to any one of (16) to (21), wherein the relay circuitry is configured to receive the control information via a PSCCH or a PSSCH addressed to the receiver, the received control information having been multiplexed with control information addressed to the receiver.

### 23

The relay device according to any one of (16) to (22), wherein the relay circuitry is configured to receive the control information in a downlink resource transmitted from the base station.

### 24

The relay device according to any one of (16) to (23), wherein the relay circuitry is configured to receive the control information using downlink control information (DCI) addressed to the relay device.

### 25

The relay device according to any one of (16) to (24), wherein DCI includes information regarding sidelink between the transmitter and the receiver.

### 26

The relay device according to any one of (16) to (25), wherein a format of the control information is different from a format of control information addressed to the receiver.

### 27

The relay device according to any one of (16) to (26), wherein the control information varies depending on a cast type of sidelink communication.

### 28

A communication device comprising:
circuitry configured to transmit control information to relay relay configured to transmit a sidelink signal received from a transmitter through a first link to a receiver through a second link,
wherein the control information is used by the relay circuitry to transmit the sidelink signal to the receiver.

### 29

The communication device according to (28), wherein the circuitry is configured to transmit the control information via a control channel different from a physical sidelink control channel (PSCCH) or a physical sidelink shared channel (PSSCH) addressed to the receiver.

### 30

The communication device according to (28) or (29), wherein the circuitry is configured to, prior to transmitting the control information, multiplex the control information with control information addressed to the receiver and transmit the multiplexed control information via a PSCCH or a PSSCH addressed to the receiver.

### 31

The communication device according to any one of (28) to (30), wherein the communication device is part of a base station, the circuitry being configured to transmit the control information in a downlink resource.

### 32

A communication method comprising:
transmitting a sidelink signal, having been received via a first link from a transmitter, to a receiver via a second link according to control information,
wherein the control information is received from at least one of a base station, the transmitter, the receiver, or communication circuitry different from the base station, the transmitter, and the receiver.

### 33

A communication method comprising:
transmitting control information to relay circuity configured to transmit a sidelink signal having been transmitted by a transmitter through a first link to a receiver through a second link,
wherein the control information is used by the relay circuitry to transmit the sidelink signal to the receiver.

### REFERENCE SIGNS LIST

20 Base station
21, 32, 41 Signal processing unit
22, 33, 42 memory
23, 34, 43 Control unit
30 Relay device
31 Relay unit
40 Terminal device
S Communication system

1. A relay device comprising:
circuitry configured to transmit a sidelink signal, which is received through a first link from a transmitter, to a receiver through a second link based on control information,
wherein the control information is received by the circuitry from at least one of a base station, the transmitter, the receiver, or communication circuitry different from the base station, the transmitter, and the receiver.

2. The relay device according to claim 1, wherein the control information includes beam information regarding beamforming in sidelink communication.

3. The relay device according to claim 1, wherein the control information includes instruction information instructing whether or not to relay sidelink communication.

4. The relay device according to claim 1, wherein the control information includes power control information regarding transmitted power in a case where the sidelink signal is transmitted to the receiver.

5. The relay device according to claim 1, wherein the circuitry is configured to receive the control information in a sidelink resource from at least one of the transmitter, the receiver, or the communication circuitry.

6. The relay device according to claim 1, wherein the circuitry is configured to receive the control information via a control channel different from a physical sidelink control channel (PSCCH) or a physical sidelink shared channel (PSSCH) addressed to the receiver.

7. The relay device according to claim 1, wherein the circuitry is configured to receive the control information via a PSCCH or a PSSCH addressed to the receiver, the received control information having been multiplexed with control information addressed to the receiver.

8. The relay device according to claim 1, wherein the circuitry is configured to receive the control information in a downlink resource transmitted from the base station.

9. The relay device according to claim 1, wherein the circuitry is configured to receive the control information using downlink control information (DCI) addressed to the relay device.

10. The relay device according to claim 9, wherein DCI includes information regarding sidelink between the transmitter and the receiver.

11. The relay device according to claim 1, wherein a format of the control information is different from a format of control information addressed to the receiver.

12. The relay device according to claim 1, wherein the control information varies depending on a cast type of sidelink communication.

13. A communication device comprising:
circuitry configured to transmit control information to relay circuitry configured to transmit a sidelink signal received from a transmitter through a first link to a receiver through a second link,
wherein the control information is used by the relay circuitry to transmit the sidelink signal to the receiver.

14. The communication device according to claim 13, wherein the circuitry is configured to transmit the control information via a control channel different from a physical sidelink control channel (PSCCH) or a physical sidelink shared channel (PSSCH) addressed to the receiver.

15. The communication device according to claim 13, wherein the communication circuitry is configured to, prior to transmitting the control information, multiplex the control information with control information addressed to the receiver and transmit the multiplexed control information via a PSCCH or a PSSCH addressed to the receiver.

16. The communication device according to claim 13, wherein the communication device is part of a base station, the circuitry being configured to transmit the control information in a downlink resource.

17. A communication method comprising:
transmitting a sidelink signal, having been received via a first link from a transmitter, to a receiver via a second link according to control information,
wherein the control information is received from at least one of a base station, the transmitter, the receiver, or communication circuitry different from the base station, the transmitter, and the receiver.

18. A communication method comprising:
transmitting control information to relay circuity configured to transmit a sidelink signal having been transmitted by a transmitter through a first link to a receiver through a second link,
wherein the control information is used by the relay circuitry to transmit the sidelink signal to the receiver.
